(19) United States
(12) Patent Application Publication
(10) Pub. No.: US 2025/0036016 A1
(43) Pub. Date: Jan. 30, 2025

(54) PROJECTION OPTICAL SYSTEM AND PROJECTION DISPLAY APPARATUS

(71) Applicant: Panasonic Intellectual Property Management Co., Ltd., Osaka (JP)

(72) Inventor: Norikazu Yamamoto, Kyoto (JP)

(21) Appl. No.: 18/752,165

(22) Filed: Jun. 24, 2024

(30) Foreign Application Priority Data
Jul. 25, 2023 (JP) 2023-121005

(51) Int. Cl. G03B 21/20

(52) U.S. Cl. CPC G03B 21/208

(57) ABSTRACT

A projection optical system includes a plurality of lenses. The projection optical system projects projection light, to display an image formed on the video display element onto a projection target. The projection light having reflected on lens surfaces of the plurality of lenses form a ray passing through the projection optical system. Each lens surface, among the lens surfaces in the projection optical system, satisfies |X|>f/2. Where, in ray tracing using paraxial ray tracing with a marginal ray of an axial light flux passing through the projection optical system, when a first ray is a reflection of the marginal ray propagated backwards on the display surface, X denotes a distance between the display surface and a convergence plane where a reflection of the first ray on the lens surface converges, and f denotes a focal length of an entire system of the projection optical system.

### BACKGROUND

### 1. Technical Field

The present disclosure relates to a projection optical system that projects to display an image, and a projection display apparatus including the projection optical system.

### 2. Description of the Related Art

Conventional projection display apparatuses project videos onto a projection target such as a screen or a building. A video projected on the projection target is sometimes captured as an image, for the purpose of checking the positional relationship between the projection target and the projected video (skew). In such a projection display apparatus, reflections on a lens surface included in a projection optical system may become a cause of a deterioration of the image quality.

Patent Literature (PTL) 1 discloses an imaging optical system for reducing, in a telecentric system including a filter, flares caused by light having reflected on the imaging surface, and reflected again on the filter.
PTL 1: Unexamined Japanese Patent Publication No. 1991-078716

### SUMMARY

An object of the present disclosure is to provide a projection optical system and a projection display apparatus capable of suppressing the deterioration in the image quality due to reflections on a lens surface.

In order to achieve the above object, a projection optical system according to an exemplary embodiment of the present disclosure is a projection optical system that includes a plurality of lenses. The projection optical system projects projection light output from a video display element in a forward direction along an optical axis, to display an image formed on a display surface of the video display element onto a projection target. The projection light having reflected on lens surfaces of the plurality of lenses form a ray passing through the projection optical system in a backward direction. Each lens surface, among the lens surfaces in the projection optical system, satisfies following condition (1),

$$\vert X \vert > f / 2 \qquad ( 1 )$$

where, in ray tracing using paraxial ray tracing with a marginal ray of an axial light flux passing through the projection optical system, when a first ray is a reflection of the marginal ray propagated backwards on the display surface, X denotes a distance between the display surface and a convergence plane where a reflection of the first ray on the lens surface converges, and f denotes a focal length of an entire system of the projection optical system.

According to the present disclosure, it is possible to provide a projection optical system and a projection display apparatus capable of suppressing a deterioration in the image quality due to reflections on a lens surface.

### BRIEF DESCRIPTION OF THE DRAWINGS

FIG. 1 is a block diagram illustrating a configuration example of a projection display apparatus according to a first exemplary embodiment of the present disclosure;

FIG. 2 is a conceptual diagram illustrating one example of a propagation optical system included in the projection display apparatus illustrated in FIG. 1;

FIG. 3 is a conceptual diagram illustrating another example of the propagation optical system included in the projection display apparatus illustrated in FIG. 1;

FIG. 4 is a schematic for describing how condition (1) is satisfied by the projection optical system according to the first exemplary embodiment of the present disclosure;

FIG. 5 is a schematic for describing how condition (2) is satisfied by the projection optical system according to the first exemplary embodiment of the present disclosure;

FIG. 6 is a schematic for describing how condition (3) is satisfied by the projection optical system according to the first exemplary embodiment of the present disclosure;

FIG. 7 is a diagram of a lens arrangement in a projection optical system according to Example 1;

FIG. 8 is an aberration diagram illustrating various aberrations in the projection lens system according to Example 1;

FIG. 9 is a lens arrangement diagram of a projection lens system according to Example 2;

FIG. 10 is an aberration diagram illustrating various aberrations in the projection lens system according to Example 2;

FIG. 11 is a lens arrangement diagram of a projection lens system according to Comparative Example 1;

FIG. 12 is an aberration diagram illustrating various aberrations in the projection lens system according to Comparative Example 1;

FIG. 13A is a table indicating how condition (1) is satisfied by the projection optical system according to Example 1;

FIG. 13B is a table indicating how condition (2) is satisfied by the projection optical system according to Example 1;

FIG. 13C is a table indicating how condition (3) is satisfied by the projection optical system according to Example 1;

FIG. 14A is a table indicating how condition (1) is satisfied by the projection optical system according to Example 2;

FIG. 14B is a table indicating how condition (2) is satisfied by the projection optical system according to Example 2;

FIG. 14C is a table indicating how condition (3) is satisfied by the projection optical system according to Example 2;

FIG. 15A is a table indicating how condition (1) is satisfied by the projection optical system according to Comparative Example 1;

FIG. 15B is a table indicating how condition (2) is satisfied by the projection optical system according to Comparative Example 1;

FIG. 15C is a table indicating how condition (3) is satisfied by the projection optical system according to Comparative Example 1;

FIG. 16 is a diagram illustrating propagation of light in a projection optical system that uses the propagation optical system according to Example 1;

FIG. 17 is a diagram illustrating image formation in the propagation optical system illustrated in FIG. 16;

FIG. 18 is a diagram illustrating propagation of light in a projection optical system that uses the propagation optical system according to Comparative Example 1; and

FIG. 19 is a diagram illustrating image formation in the propagation optical system illustrated in FIG. 18.

### DETAILED DESCRIPTIONS

Provided according to a first aspect of the present disclosure is a display surface projection optical system that includes a plurality of lenses. The projection optical system projects projection light output from a video display element in a forward direction along an optical axis, to display an image formed on a display surface of the video display element onto a projection target. The projection light having reflected on lens surfaces of the plurality of lenses form a ray passing through the projection optical system in a backward direction. Each lens surface, among the lens surfaces in the projection optical system, satisfies following condition (1),

$$\vert X \vert > f / 2 \qquad ( 1 )$$

where, in ray tracing using paraxial ray tracing with a marginal ray of an axial light flux passing through the projection optical system, when a first ray is a reflection of the marginal ray propagated backwards on the display surface, X denotes a distance between the display surface and a convergence plane where a reflection of the first ray on the lens surface converges, and f denotes a focal length of an entire system of the projection optical system.

Provided according to a second aspect of the present disclosure is a projection optical system that includes a plurality of lenses. The projection optical system projects projection light output from a video display element in a forward direction along an optical axis, to display an image formed on a display surface of the video display element onto a projection target. The projection light having reflected on lens surfaces of the plurality of lenses form a ray passing through the projection optical system in a backward direction. Each lens surface, among the lens surfaces in the projection optical system, satisfies following condition (2),

$$\vert ( H * f / 2 F ) \vert > D \qquad ( 2 )$$

where, in ray tracing using paraxial ray tracing with a marginal ray of an axial light flux passing through the projection optical system, when a first ray is a reflection of the marginal ray propagated backwards on the display surface, H denotes a ray height, on the display surface, of a ray resultant of the first ray reflected on the lens surface, and D denotes a half a diagonal length of the display surface, f is a focal length of the entire projection optical system, and F is an f-number of the entire projection optical system.

According to a third aspect of the present disclosure, there is provided a projection optical system that includes a plurality of lenses. The projection optical system projects projection light output from a video display element in a forward direction along an optical axis, to display an image formed on a display surface of the video display element onto a projection target. The projection light having reflected on lens surfaces of the plurality of lenses form a ray passing through the projection optical system in a backward direction. Each lens surface, among the lens surfaces in the projection optical system, satisfies following condition (3),

$$1 / ( \vert θ \vert * h ) < 0.04 \qquad ( 3 )$$

where in ray tracing using actual ray tracing with a marginal ray of an axial light flux passing through the projection optical system, when θ deg. denotes an angle formed by the marginal ray having propagated forwards from the display surface and becoming incident on the lens surface, and a normal line of the lens surface on which the marginal ray becomes incident, and h mm denotes a ray height on the lens surface on which the marginal ray becomes incident.

Provided according to a fourth aspect of the present disclosure is a projection optical system that includes a plurality of lenses. The projection optical system projects projection light output from a video display element in a forward direction along an optical axis, to display an image formed on a display surface of the video display element onto a projection target. The projection light having reflected on lens surfaces of the plurality of lenses form a ray passing through the projection optical system in a backward direction. each lens surface, among the lens surfaces in the projection optical system, satisfies at least one of following conditions (1) to (3) in ray tracing with a marginal ray of an axial light flux passing through the projection optical system:

$$\vert X \vert > f / 2 ; \qquad ( 1 )$$

$$\vert ( H * f / 2 F ) \vert > D ; \qquad ( 2 )$$

$$and$$

$$1 / ( \vert θ \vert * h ) < 0 \text{.04} , \qquad ( 3 )$$

where, in the ray tracing using paraxial ray tracing when a first ray is a reflection of the marginal ray propagated backwards on the display surface, X denotes a distance between the display surface and a convergence plane where a reflection of the first ray on the lens surface converges, f denotes a focal length of an entire system of the projection optical system, H denotes a ray height, on the display surface, of a reflection of the first ray on the lens surface, among the lens surfaces, in the ray tracing using paraxial ray tracing, F is an f-number of the entire projection optical system, D denotes a half a diagonal length of the display surface, θ deg. denotes an angle formed by the marginal ray having propagated forwards from the display surface and becoming incident on the lens surface, and a normal line of the lens surface on which the marginal ray becomes incident, in the ray tracing using actual ray tracing, and h (mm) denotes a ray height, on the lens surface, when the marginal ray becomes incident on the lens surface.

According to any one of the above aspects, it is possible to suppress a deterioration in the image quality due to reflections on a lens surface.

Provided according to a fifth aspect of the present disclosure is the projection optical system according to any one of the first to fourth aspects, in which the ray tracing is performed using a light wavelength included in the projection light.

Provided according to a sixth aspect of the present disclosure is the projection optical system according to any one of the first to the fourth aspects, in which external light propagating from the projection target in the backward direction along the optical axis passes through the projection optical system, and light in a predetermined wavelength range in the external light forms a captured image, and the ray tracing is performed using a light wavelength included in the predetermined wavelength range.

Provided according to a seventh aspect of the present disclosure is a projection display apparatus that projects and displays a video on the projection target, the projection display apparatus including: a light source device; a projection light generator that includes one or more video display elements and generates the projection light modulated in accordance with a video signal; a light-guide optical system that guides illumination light emitted from the light source device to the projection light generator; and the projection optical system according to any one of the first to the fourth aspect, in which the ray tracing is performed using a light wavelength included in the projection light.

Provided according to an eighth aspect of the present disclosure is a projection display apparatus that projects and displays a video on the projection target, the projection display apparatus including: a light source device; a projection light generator that includes one or more video display elements and generates the projection light modulated in accordance with a video signal; a light-guide optical system that guides illumination light emitted from the light source device to the projection light generator; the projection optical system according to any one of the first to the fourth aspect; and an imaging optical system in which external light propagating from the projection target in the backward direction along the optical axis passes through the projection optical system and captures an image of light in a predetermined wavelength range among the external light, in which the ray tracing is performed using a light wavelength included in the predetermined wavelength range.

Note that by appropriately combining discretionary exemplary embodiments among the various exemplary embodiments described above, the effects of the respective exemplary embodiments can be achieved.

Exemplary embodiments will be described below in detail with reference to some drawings, as appropriate. Descriptions more in detail than necessary may be omitted. For example, detailed descriptions of already well-known matters and the redundant description of substantially identical configurations may be omitted. These omissions are made to avoid an unnecessarily redundancy in the description below, and to facilitate understanding of those skilled in the art.

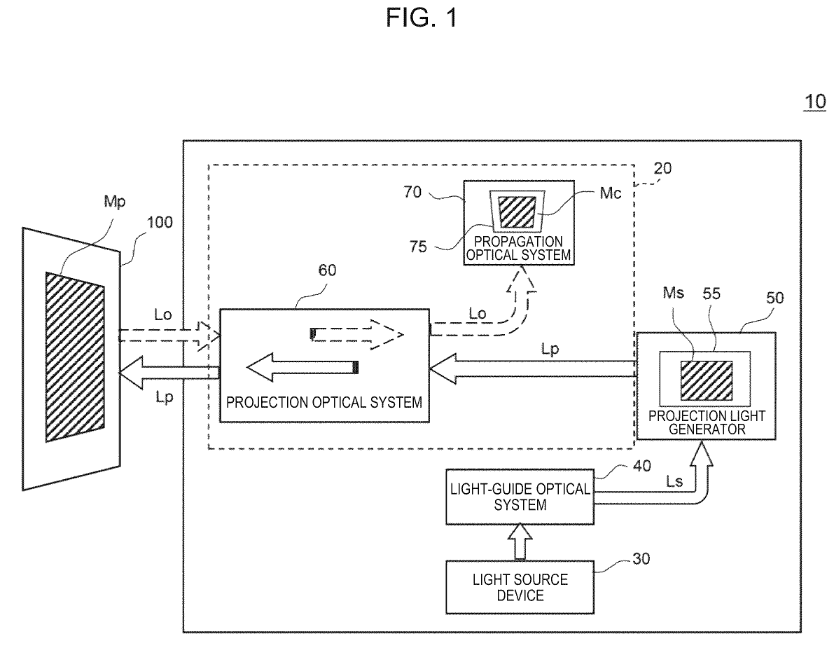

A projection optical system and a projection display apparatus according to a first exemplary embodiment of the present disclosure will now be described with reference to FIGS. 1 to 19. The accompanying drawings and the following description are provided for those skilled in the art to fully understand the present disclosure, and are not intended to limit the subject matter described in the claims in any way. Furthermore, in each of the drawings, elements are illustrated exaggeratedly in order to facilitate the description. Note that, in the drawings, substantially the same members are denoted by the same reference signs.

### First Exemplary Embodiment

### (Overall Configuration of Projection Display Apparatus)

A projection display apparatus according to a first exemplary embodiment will now be described with reference to FIG. 1. FIG. 1 is a block diagram illustrating a configuration example of projection display apparatus 10 according to the first exemplary embodiment of the present disclosure.

As illustrated in FIG. 1, projection display apparatus 10 may include light source device 30, light-guide optical system 40, projection light generator 50, and projection optical system 60. In some examples, projection display apparatus 10 may further include imaging optical system 70. Projection display apparatus 10 causes projection light generator 50 to generate projection light Lp corresponding to input video signals, on the basis of the light emitted from light source device 30, and projects projection light Lp generated by projection optical system 60 forwards so as to display a video on projection target 100 such as a screen. In some examples, projection optical system 60 may collect external light Lo reflected by projection target 100 in the backward direction so that external light Lo is guided into imaging optical system 70 via projection optical system 60 and an image of external light Lo is captured thereby.

Light source device 30 includes a light source, and an illumination optical system that includes various color combining structures. Examples of the light source include a high-pressure mercury lamp, a xenon lamp, an LED, and a semiconductor laser. Examples of the illumination optical system includes a wavelength converter, a light tunnel, and a relay optical system. The light from the light source propagates along the illumination optical system, and illumination light Ls is output from light source device 30.

Light-guide optical system 40 guides illumination light Ls output from light source device 30 into projection light generator 50. Light-guide optical system 40 is configured as appropriate arrangement of various optical members, such as various lenses, mirrors, and rods. Illumination light Ls is guided into projection light generator 50, and irradiates video display element 55 with illumination light Ls having a uniform illuminance distribution.

Video display element 55 may be a digital mirror device (DMD), for example. Video display element 55 has, for example, a display surface including a mirror element corresponding to each pixel, and forms image Ms on the display surface, on the basis of image signals from external, using illumination light Ls incident thereon. Video display element 55 modulates illumination light Ls in accordance with the image signals, generates projection light Lp, and outputs projection light Lp to projection optical system 60.

Note that the projection display apparatus 10 may be a one-chip DLP projector including one video display element 55 or a three-chip DLP projector including a plurality of video display elements 55. Video display element 55 is not limited to a DMD, and may also be a liquid crystal element, for example. In the latter case, projection display apparatus 10 may be configured as a 3LCD device or an LCOS device.

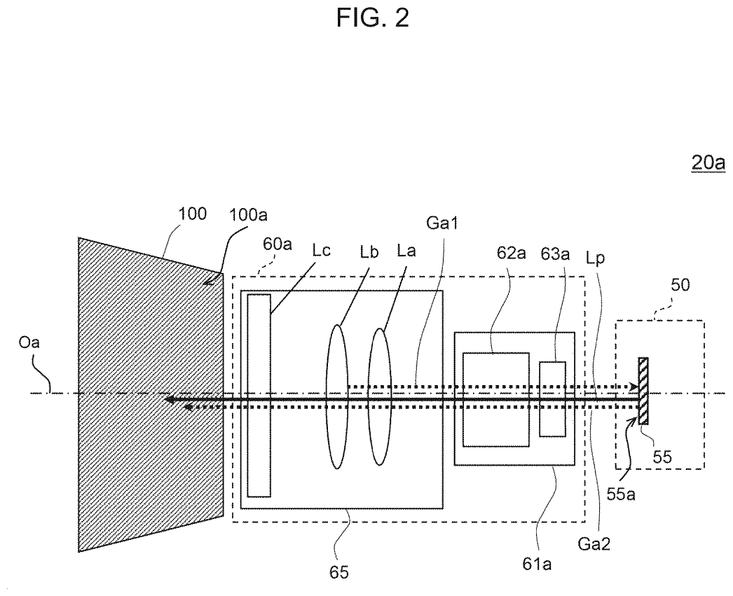

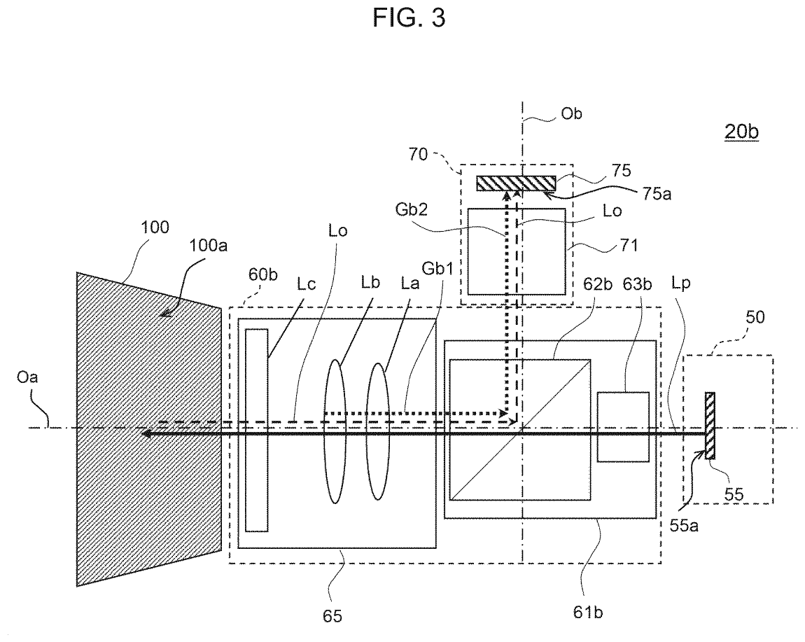

Projection optical system 60 includes a plurality of lenses (not illustrated in FIG. 1; see FIGS. 2 and 3 described later), and displays video Mp by propagating projection light Lp from projection light generator 50 in the frontward direction (toward the left in the drawing) and projecting projection light Lp onto projection target 100. The configuration of projection optical system 60 will now be described in detail later.

In the present exemplary embodiment, projection optical system 60 can collect external light Lo having reflected on projection target 100 and propagating in the backward direction (toward the right in the drawing). External light Lo having become incident passes through projection optical system 60, and is guided into imaging optical system 70. Imaging optical system 70 includes imaging element 75, and forms an image of external light Lo having become incident thereon via projection optical system 60, as captured image Mc on the imaging surface of imaging element 75.

Projection display apparatus 10 may further include a control device (not illustrated) that controls the entire operation of the device. The control device may include, for example, a video input terminal for inputting video signals from the outside, and various drivers. The control device is configured to control an operation of light source device 30, the supply of the video signals to video display element 55, and driving of video display element 55, for example. Detailed descriptions of the control device are omitted herein.

As described above, various optical elements are disposed between video display element 55 and projection target 100, and propagate projection light Lp, or projection light Lp and external light Lo. In the description herein, an optical system disposed between video display element 55 and projection target 100, and including various optical elements that propagate projection light Lp or projection light Lp and external light Lo will be referred to as a “propagation optical system”. For example, propagation optical system 20 in projection display apparatus 10 illustrated in FIG. 1 includes projection optical system 60 and imaging optical system 70. A configuration of the propagation optical system in projection display apparatus 10 according to the present disclosure will be now described with reference to FIGS. 2 and 3.

### (Configuration of Propagation Optical System)

FIG. 2 is a conceptual diagram illustrating an example (propagation optical system 20a) of the propagation optical system in projection display apparatus 10 in FIG. 1, and FIG. 3 is a conceptual diagram illustrating another example (propagation optical system 20b) of the propagation optical system in projection display apparatus 10 in FIG. 1. Propagation optical system 20a in FIG. 2 can display a video on projection surface 100a by projecting projection light Lp from video display element 55 onto projection target 100. Propagation optical system 20b in FIG. 3 can not only project projection light Lp from video display element 55 onto projection target 100, but also guide external light Lo from projection target 100 to imaging optical system 70 via projection optical system 60b to form an image on imaging surface 75a of imaging element 75.

As illustrated in FIG. 2, propagation optical system 20a includes projection optical system 60a. Projection light Lp is output from video display element 55 included in projection light generator 50, propagates along projection optical axis Oa, and become incident on projection optical system 60a.

Projection optical system 60a in propagation optical system 20a may include back glass member 61a and lens unit 65, for example. In the present exemplary embodiment, back glass member 61a may include prism element 62a such as a total internal reflection (TIR) prism, a color separation prism, and a color synthesis prism, and optical element 63a such as various types of optical filters and a cover glass. Lens unit 65 may include a plurality of lens elements La, Lb, Lc and diaphragm A (not illustrated in FIG. 2). The number of lens elements La, Lb, Lc may be fifteen or more, without limitation thereto. With this, it is possible to correct various aberrations in projection optical system 60a. An example of diaphragm A is an aperture diaphragm. Projection optical system 60a may be configured as a module, and mounted on projection display apparatus 10, for example. Projection light Lp incident on projection optical system 60a passes through back glass member 61a and lens unit 65 in the order listed herein, and then projected onto projection surface 100a of projection target 100 in an enlarged size. In propagation optical system 20a, display surface 55a of the video display element and projection surface 100a of the projection target are in a conjugate relationship.

When projection light Lp passes through lens unit 65, projection light Lp becomes reflected on the lens surfaces of the plurality of lens elements La, Lb, Lc, and the reflected light propagate in the backward direction (toward the right in the drawing). Reflected light Ga1 from the lens surfaces may pass through projection optical system 60a in the backward direction, and reach video display element 55. Reflected light Ga1 reflected on the lens surfaces is reflected again on elements such as the display surface including the mirror element in video display element 55 and a polarizer plate in optical element 63a, and generate re-reflected light Ga2 propagating in the forward direction (toward the left in the drawing). This re-reflected light Ga2 may be projected onto projection target 100 by projection optical system 60a, and form another image that is different from that formed by projection light Lp. This results in a reduced contrast of the video of projection light Lp being displayed on projection target 100, and deteriorates the image quality of the video.

Propagation optical system 20b illustrated in FIG. 3 includes projection optical system 60b and imaging optical system 70. Propagation optical system 20b is different from propagation optical system 20a in FIG. 2 in including imaging optical system 70. In propagation optical system 20b in FIG. 3, the same elements as those in propagation optical system 20a in FIG. 2 are denoted by the same reference numerals, and the descriptions thereof will be omitted.

In propagation optical system 20b, projection light Lp is output from video display element 55 included in projection light generator 50, becomes incident on projection optical system 60b in the forward direction (leftward direction in the drawing), and is projected on projection surface 100a of projection target 100 in an enlarged size. External light Lo from projection target 100 passes through projection optical system 60b in the backward direction (toward the right in the drawing), is guided into imaging optical system 70, and forms an image on imaging surface 75a of imaging element 75.

Projection optical system 60b in propagation optical system 20b includes, for example, back glass member 61b and lens unit 65. Back glass member 61b may include a prism element such as separation prism 62b, and optical element 63b such as various optical filters and a cover glass. Lens unit 65 includes a plurality of lens elements La, Lb, Lc and diaphragm A (not illustrated in FIG. 2). Although not illustrated, back glass member 61b may include a prism element such as a total internal reflection (TIR) prism, a color separation prism, or a color synthesizing prism, in addition to separation prism 62b.

Imaging optical system 70 may include, for example, prism spacer 71 and imaging element 75. Prism spacer 71 is an element for aligning the back focus of imaging element 75. External light Lo incident on prism spacer 71 passes through prism spacer 71, and becomes incident on imaging element 75. Imaging element 75 may be a solid-state imaging element such as a CCD image sensor or a CMOS image sensor. Imaging element 75 converts external light Lo incident thereon into an electrical image signal, and forms an image on imaging surface 75a. In propagation optical system 20b, display surface 55a of the video display element, projection surface 100a of the projection target, and imaging surface 75a of the imaging element are in a conjugate relationship.

In the same manner as in propagation optical system 20a described above, in propagation optical system 20b, when projection light Lp passes through lens unit 65, projection light Lp becomes reflected on the lens surfaces of the plurality of lens elements La, Lb, Lc, and the reflected light propagate in the backward direction (toward the right in the drawing). Reflected light Gb1 having reflected on such lens surfaces is reflected again on separation prism 62b, and is turned into re-reflected light Gb2 propagating along optical axis Ob illustrated in FIG. 3. With this re-reflected light Gb2 becoming incident on imaging optical system 70, an image different from that formed by external light Lo can be formed on the imaging surface of imaging element 75. This results in a reduced contrast of the captured image formed by external light Lo being displayed on the imaging surface of imaging element 75, and deteriorates the image quality of the captured image.

In the description herein, the side of projection target 100 is a magnifying side of entire projection optical system 60a, 60b. Projection surface 100a of such projection target 100 will be sometimes referred to as an “object plane”, and the side of projection target 100 will be sometimes referred to as an “object plane side”. The side of video display element 55 is a reducing side of the entire systems of projection optical systems 60a, 60b. Display surface 55a of such video display element 55 will be sometimes referred to as an “image plane”, and the side of video display element 55 will be sometimes referred to as an “image plane side”.

Note that the configurations of propagation optical systems 20a, 20b illustrated in FIGS. 2 and 3, respectively, are conceptual configuration examples for describing the propagations of projection light Lp and external light Lo, and the present disclosure is not limited thereto. Other optical components may be further included in the propagation optical system in the projection display apparatus according to the present disclosure. Furthermore, propagation optical systems 20a, 20b are illustrated as including one video display element 55, as one example, but the present disclosure is not limited thereto. The propagation optical system in the projection display apparatus according to the present disclosure may have a configuration including a plurality of video display elements.

As described with reference to FIGS. 2 and 3, when projection light Lp passes through projection optical system 60a, 60b, projection light Lp is reflected on the lens surfaces of the plurality of lens elements La, Lb, Lc included in lens unit 65, and turn into reflected light Ga1, Gb1 passing through projection optical systems 60a, 60b in the backward direction. Reflected light Ga1, Gb1 is sometimes re-reflected in the projection optical system, and forms an image that is different from that formed by projection light Lp or by external light Lo, on projection target 100 or imaging element 75, respectively. In the description herein, reflected light resultant of the reflection of projection light Lp on the lens surfaces of the lens elements in the projection optical system, such as reflected light Ga1, Gb1 and re-reflected light Ga2, Gb2 illustrated in FIGS. 2 and 3, will be referred to as “ghost light”, and an image formed by the ghost light will be referred to as a “ghost image”. When a ghost image is formed on projection target 100 or imaging element 75, the contrast of the video or the captured image is reduced, and the image quality of the projection display apparatus deteriorates.

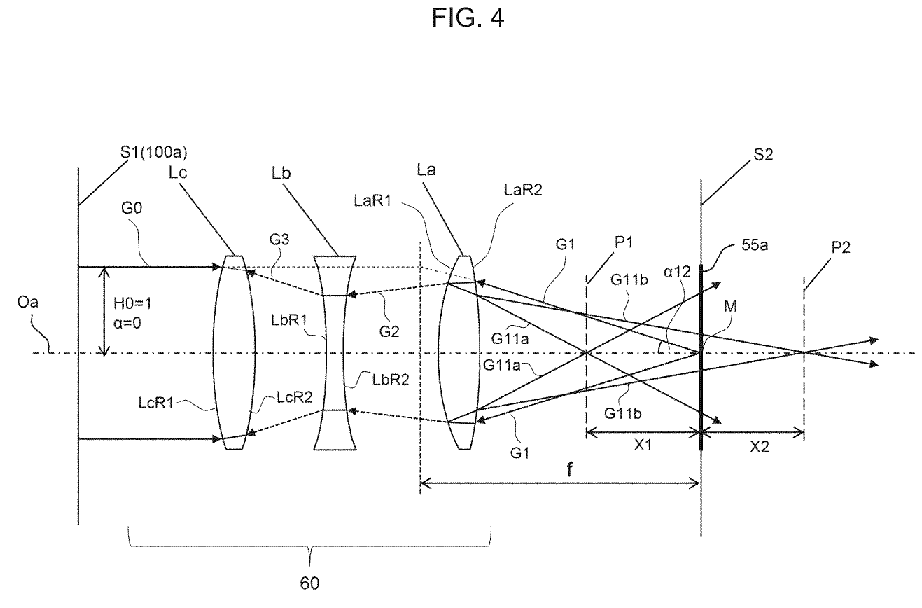

To address this issue, according to the present disclosure, the projection optical system is configured in a manner suppressing formation of a ghost image. As a result, it is possible to prevent the ghost light resultant of light reflection on the lens surface of the lens element in the projection optical system from forming a ghost image on the projection target or the imaging element, to improve the contrast between the video and the captured image, and to improve the image quality of the projection display apparatus. Conditions to be satisfied by the projection optical system according to the present exemplary embodiment will now be described with reference to FIGS. 4 to 6.

### (Condition (1) to be Satisfied by Projection Optical System)

FIG. 4 is a schematic for describing how condition (1) is satisfied by projection optical system 60 according to the first exemplary embodiment of the present disclosure. Condition (1) illustrated in FIG. 4 is a condition for the configuration of the projection optical system, obtained by running ray tracing that uses paraxial ray tracing with a marginal ray of an axial light flux passing through projection optical system 60 in a direction from object plane S1 to image plane S2. Object plane S1 of the projection optical system corresponds to the plane on which projection target 100 is positioned. Image plane S2 corresponds to a plane on which display surface 55a of the video display element is positioned.

In the description herein, the “axial light flux” is a flux of rays output along optical axis Oa, and is a flux of rays contributing to the formation of an image. The “marginal ray of the axial light flux” is a ray passing through the outermost side (the position away from the optical axis) of the axial light flux. The paraxial ray tracing is a simulation technique for geometrically and optically calculating the sequence of paths along which a ray propagates, with the effect of the transmission through, refraction in, and reflections on the surface of each optical element included in an optical system, under the assumption of a paraxial ray.

Under the paraxial assumption, for example, denoting the curvature radius of the lens surface as r; denoting the inclination angle formed by the ray becoming incident on the lens surface with respect to the optical axis as α1; denoting the distance between the optical axis and the position where the ray arrives at the lens surface as a ray height h; and denoting the refractive indices of an incident side and an exit side as n1 and n2, respectively, inclination angle α2 formed by the exiting ray leaving the lens surface and the optical axis is calculated by following Equation:

$$\begin{matrix}( a ) & \\ n2 * α2 = n 1 * α1 + ( n 2 - n 1 ) * ( h / r ) . & \end{matrix}$$

In this manner, exit inclination angle α2 having gone through a refraction on a predetermined lens surface can be calculated from ray height h and incident inclination angle α1 on the lens surface. By carrying over inclination angle α2 as an input value for the incident inclination angle of the next lens surface, the inclination angles and the ray heights of the ray arriving at respective consecutive lens surfaces can be calculated, sequentially. The paraxial ray tracing may be implemented on the basis of known techniques, and therefore, further detailed description will be omitted.

Specifically, as illustrated in FIG. 4, paraxial ray tracing is executed for the point of convergence on the image plane. Under the paraxial assumption, marginal ray G0 of the axial light flux from object plane S1 at an object distance ∞ becomes incident on projection optical system 60, as a ray in parallel with optical axis Oa, that is, a ray at an inclination angle α=0 degrees with respect to the optical axis and a ray height H0=1, passes through projection optical system 60, and converges at focal point M at which image plane S2 intersects with optical axis Oa. At this time, the focal length of entire projection optical system 60 is denoted as f.

Ray G1 resultant of reflecting on image plane S2 propagates toward object plane S1 at inclination angle α12, reaches right lens surface LaR2 of lens element La, is refracted inside lens element La, and then reaches left lens surface LaR1.

The ray is then reflected on lens surface LaR1 as a lens reflection surface, and the reflected ray travels toward image plane S2, is refracted inside lens surface LaR2, and output from projection optical system 60. This ray G11a having exited then converges at convergence plane P1. Under these assumptions, distance X1 between convergence plane P1 and image plane S2 can be calculated.

In FIG. 4, ray G11a output from projection optical system 60 is conceptually illustrated as having a focal point at optical axis Oa, but the present disclosure is not limited thereto. For example, in some actual optical systems, it is possible for the ray reflected on the lens reflection surface and output from the projection optical system not to have a focal point on optical axis Oa, due to aberration. In the description herein, a convergence plane refers to a plane including the position of a focal spot or a beam waist of the ray reflected on a lens reflection surface and output from projection optical system 60. Furthermore, although convergence plane P1 of ray G11a is illustrated to be on the under side (left side in the drawing) of image plane S2, the ray having exited projection optical system 60 may converge on convergence plane P2 on the over side (right side in the drawing) of image plane S2, as illustrated as ray G11b in FIG. 4, for example. Distance X2 between convergence plane P2 and image plane S2 is then calculated. The absolute values of calculated distances X1, X2 are denoted as |X|.

In the manner described above, the projection optical system can be configured in such a manner that each of the lens surfaces of lens elements La, Lb, Lc, . . . included in projection optical system 60 satisfies following condition (1) in the paraxial ray tracing executed for the lens surface, with a paraxial ray taking a path following object plane S1→image plane S2→the lens reflection surface→convergence plane P1, P2, in the order listed herein.

$$\vert X \vert > f / 2 \qquad ( 1 )$$

where X denotes the distance between image plane S2 and the convergence plane where the marginal ray of the axial light flux converges, in the paraxial ray tracing, after the marginal ray travels from object plane S1 in the backward direction, passes through projection optical system 60, reflects on image plane S2, where display surface 55a of the video display element is disposed, and reflects on the corresponding lens surface in the projection optical system. f denotes the focal length of entire projection optical system 60.

When each of the lens surfaces of the lens elements included in the projection optical system satisfies condition (1), the focal depth of the ghost images formed by ghost light Ga1, Ga2 or Gb1, Gb2 resultant of reflections of projection light Lp illustrated in FIG. 2 or 3 on the lens surfaces of the lens elements in the projection optical system are offset from projection surface 100a of projection target 100 or imaging surface 75a of imaging element 75, projection surface 100a and imaging surface 75a being conjugate planes of video display element 55. In this manner, it is possible to suppress a decrease in the contrast in the video or the captured image, caused by a ghost image, and to improve the image quality of the projection display apparatus.

### (Condition (2) to be Satisfied by Projection Optical System)

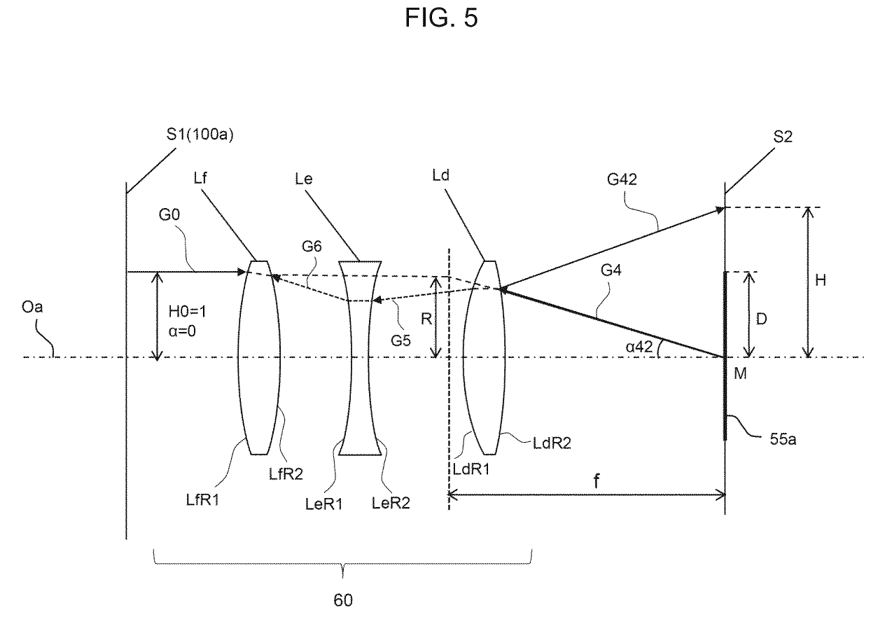

FIG. 5 is a schematic for describing how condition (2) is satisfied by projection optical system 60 according to the first exemplary embodiment of the present disclosure. Condition (2) illustrated in FIG. 5 is a condition for the configuration of the projection optical system, obtained by running paraxial ray tracing of the marginal ray of the axial light flux passing through projection optical system 60 in a direction from object plane S1 to image plane S2.

Specifically, as illustrated in FIG. 5, paraxial ray tracing is executed for the point of convergence on the image plane. Under the paraxial assumption, marginal ray G0 of the axial light flux from object plane S1 at an object distance ∞ becomes incident on projection optical system 60, as a ray in parallel with optical axis Oa, that is, a ray at an inclination angle α=0 degrees with respect to the optical axis and a ray height H0=1, passes through projection optical system 60, and converges at focal point M at which image plane S2 intersects with optical axis Oa. At this time, the focal length of entire projection optical system 60 is denoted as f.

Ray G4 having reflected on image plane S2 propagates toward object plane S1 at inclination angle α42, and becomes incident on right lens surface LdR2 of lens element Ld. Ray G42 reflected on lens surface LdR2 as a lens reflection surface then leaves the lens as ray G42, and reaches image plane S2. This ray height H on image plane S2 is then calculated.

In the manner described above, the projection optical system can be configured in such a manner that each of the lens surfaces of lens elements Ld, Le, Lf, . . . included in projection optical system 60 satisfies following condition (2) in the paraxial ray tracing executed for each of the lens surfaces, with a paraxial ray taking a path following object plane S1→image plane S2→the lens reflection surface→image plane S2, in the order listed herein.

$$\vert ( H * f / 2 F ) \vert > D \qquad ( 2 )$$

where H denotes the ray height, in the paraxial ray tracing, at which the marginal ray of the axial light flux becomes incident on image plane S2 after propagating in the backward direction from object plane S1, passing through projection optical system 60, reflected on image plane S2, and reflected on the corresponding lens surface of the projection optical system. f denotes the focal length of entire projection optical system 60. F is an f-number of entire projection optical system 60, and is a value obtained by dividing the focal length f of entire projection optical system 60 by effective aperture 2R. D is a half the diagonal length of display surface 55a of the video display element.

In propagation optical system 20a, 20b illustrated in FIG. 2 or 3, it is known that, when the ray of ghost light Ga2, Gb2, which is the reflection of projection light Lp on the lens surface of a lens element in the projection optical system, forms a partial convergence in the propagation optical system, a highly intense ghost image is formed on projection surface 100a or imaging surface 75a. The formation of a partial convergence of the ray of ghost light Ga2, Gb2 can be suppressed by configuring each of the lens surfaces of the lens elements included in the projection optical system to satisfy condition (2). As a result, it is possible to prevent formation of an intense ghost image on projection surface 100a or imaging surface 75a. Therefore, it is possible to suppress a decrease in the contrast of video or captured image due to the ghost image, and to improve the image quality of the projection display apparatus. In the description herein, (H*f/2F) on the left side of above condition (2) will be sometimes referred to as a “spot size index” and denoted as “Prt_h”.

### (Condition (3) to be Satisfied by Projection Optical System)

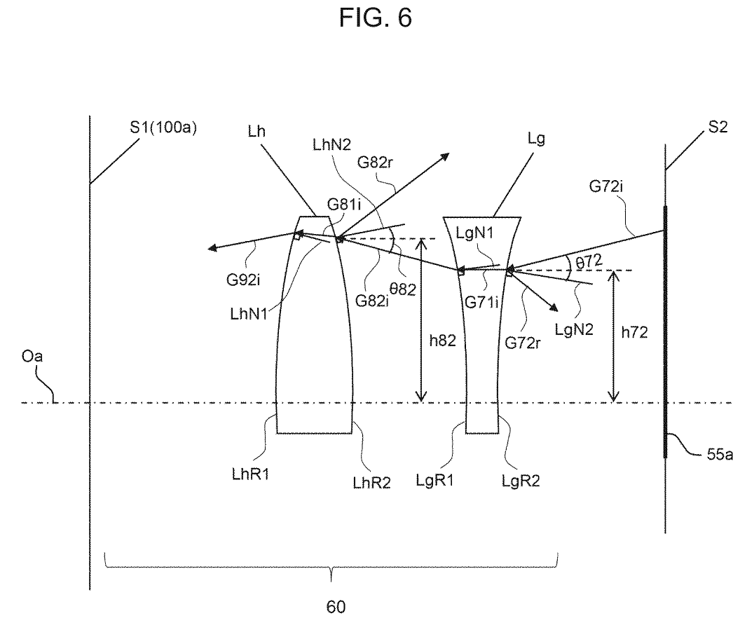

FIG. 6 is a schematic for describing how condition (3) is satisfied by projection optical system 60 according to the first exemplary embodiment of the present disclosure. Condition (3) illustrated in FIG. 6 is a condition for the configuration of the projection optical system, obtained by running actual ray tracing of the marginal ray of the axial light flux propagating from image plane S2 toward object plane S1.

In the actual ray tracing in which a ray becomes incident on a lens surface, without the paraxial assumption, when the incident angle of the ray with respect to the normal line of the lens surface is denoted as θ1, and the refractive indexes of the incident side and the exit side are denoted as n1 and n2, respectively, exit angle θ2 formed by the exiting ray leaving the lens surface and the normal line of the lens surface is calculated based on Snell's law, that is, using following formula (b).

$$\begin{matrix}( b ) & \\ n 2 * sin θ 2 = n 1 * sin θ1 & \end{matrix}$$

In this manner, exit angle θ2 of a ray leaving a predetermined lens surface can be calculated on the basis of incident angle θ1 of the lay having become incident on the lens surface. In the actual ray tracing, exit angle θ2 is carried over as an incident angle of the ray becoming incident on the next lens surface. Therefore, it is possible to calculate the incident angle and the ray height of the ray arriving at each of the successive lens surfaces, sequentially, in accordance with the Gaussian equation for the refractive surface or the like. The actual ray tracing may be implemented on the basis of known techniques, and therefore, further detailed description will be omitted.

Specifically, as illustrated in FIG. 6, actual ray tracing is executed for the point of convergence on the image plane. In this tracing, when the marginal ray of the axial light flux from image plane S2 propagates toward object plane S1 and becomes incident on right lens surface LgR2 of lens element Lg, incident angle θ72 of incident ray G72i with respect to normal line LgN2 of lens surface LgR2 and ray height h72 on lens surface LgR2 are calculated.

Ray G72i is then not only reflected on and refracted by lens surface LgR2 as ray G72r, and but also arrives at left lens surface LgR1 lens element Lg and lens surfaces LhR2, LhR1 of lens element Lh, one after another. The incident angle and the ray height of ray G becoming incident on each of these lens surface can therefore be sequentially calculated.

In this manner, the projection optical system can be configured in such a manner that each of the lens surfaces of lens elements Lg, Lh, . . . included in projection optical system 60 satisfies following condition (3) in the actual ray tracing executed for the marginal ray of the axial light flux from image plane S2.

$$1 / ( \vert θ \vert * h ) < 0.04 \qquad ( 3 )$$

where θ (deg) denotes, in the actual ray tracing in which the marginal ray of the axial light flux propagating in the forward direction from image plane S2 becomes incident on the lens surface of the projection optical system, an angle formed by the marginal ray and the normal line of the lens surface, and h (mm) denotes the ray height on the lens surface.

With condition (3) satisfied by each of the lens surfaces of the lens elements included in the projection optical system, it is more likely for the ray reflected on the lens surfaces backwardly, being reflected as projection light Lp passes through the projection optical system, to separate from the forwardly traced light path, and for the normal incident angle of the ray becoming incident on the next lens surface to diverge from the original incident angle. Therefore, the light intensity of ghost light Ga2, Gb2 (see FIG. 2 or 3) passing through the projection optical system backwards and arriving at projection surface 100a or imaging surface 75a by re-reflection is reduced. In this manner, it is possible to suppress a decrease in the contrast in the video or the captured image, caused by a ghost image, and to improve the image quality of the projection display apparatus. Note that, in the description herein, (1/(|θ|*h)) on the left side of condition (3) mentioned above will be sometimes referred to as a “Ghost index” and denoted as “Gin”.

The reference value 0.04 of ghost index Gin on the right side of condition (3) is defined by the luminance of the projection display apparatus. Projection display apparatus 10 according to the present exemplary embodiment has a high luminance of 5000 lumens or higher, for example. The reference value for ghost index Gin may be defined as 0.04 for a projection display apparatus having a luminance of 3000 lumens to 30,000 lumens, for example.

Note that FIG. 6 illustrates an example in which ghost index Gin is calculated from the incident angle and the ray height by and at which the marginal ray of the axial light flux propagating in a direction from image plane S2 toward object plane S1 becomes incident on each lens surface, but the present disclosure is not limited thereto. For example, ghost index Gin may also be calculated from the exit angle and the ray height by and at which the marginal ray of the axial light flux propagating in a direction from object plane S1 toward image plane S2 leaves the lens surface. Furthermore, the projection optical system may also be configured in such a manner that ghost index Gin thus calculated satisfies condition (3) mentioned above.

Furthermore, in the ray tracing for conditions (1) to (3) mentioned above, a light wavelength capable of forming a ghost image is preferably used. In this manner, it will become possible to suppress the decrease in the contrast of a video or captured image, caused by a ghost image, more effectively. Specifically, for example, in propagation optical system 20a illustrated in FIG. 2, ray tracing may be performed using a light wavelength included in the projection light. For example, ray tracing may be performed using a light wavelength of 550 nm within the visible light range. Furthermore, in propagation optical system 20b illustrated in FIG. 3, when light within a predetermined wavelength range, among those of external light Lo, is guided into imaging optical system 70 to capture an image thereof, the light wavelength included in the wavelength range may be used in the ray tracing. For example, but without limitation thereto, in a case where an image is captured using the light in the visible light range, the ray tracing may be performed using the light at a light wavelength of 550 nm, which is within the visible light range; and, in a case where an image is captured using light within the infrared range, the ray tracing may be performed using the light at a light wavelength of 800 nm, which is within the infrared range.

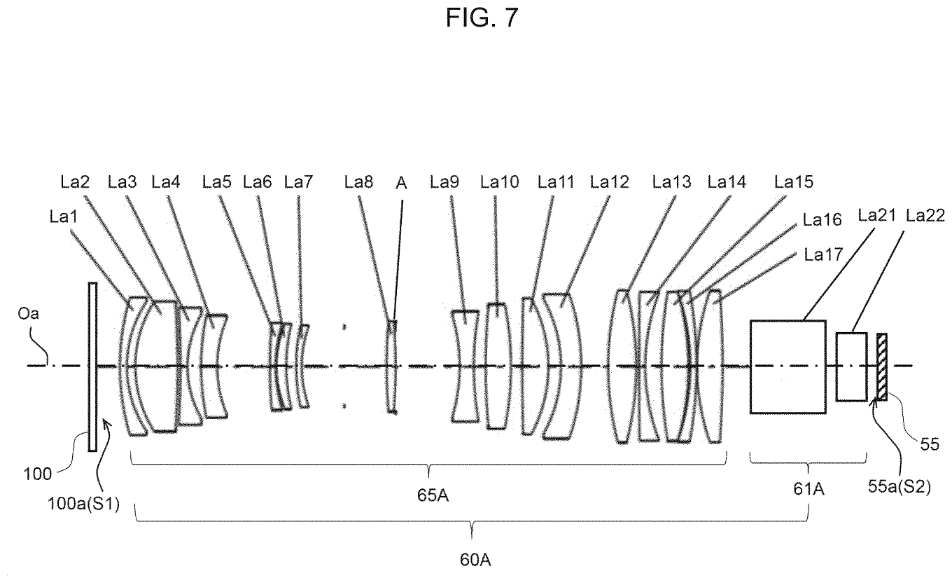

Configurations of projection optical systems according to Example 1 and Example 2, and Comparative Example 1 will now be described with reference to FIGS. 7 to 12.

### Examples and Comparative Examples

### (Lens Arrangement of Projection Optical System)

FIG. 7 is a diagram of a lens arrangement in projection optical system 60A according to Example 1. In the lens arrangement diagrams illustrated in FIGS. 7, 9, and 11, the left side corresponds to the magnifying side or the side of object plane S1 of the entire system, and corresponds to the side of projection surface 100a of projection target 100. The right side in the drawings is the reducing side or the side of image plane S2 in the entire system, and corresponds to the side of display surface 55a of video display element 55.

Projection optical system 60A in FIG. 7 includes back glass member 61A and lens unit 65A. Lens unit 65A according to Example 1 includes first to seventeen lens elements La1 to La17 arranged side by side, and each of the first to seventeenth lens elements La1 to La17 is configured as a positive lens or a negative lens. The positive lens has a biconvex shape or a positive meniscus shape, and therefore has a positive power. The negative lens has a biconcave shape or a negative meniscus shape, and therefore has a negative power. Diaphragm A is disposed on the reducing side of eighth lens element La8.

Back glass member 61A includes various prisms, filters, and cover glasses, for example. Back glass members La21, La22 for image plane S2, which corresponds to display surface 55a of video display element 55, are conceptually illustrated in FIG. 7.

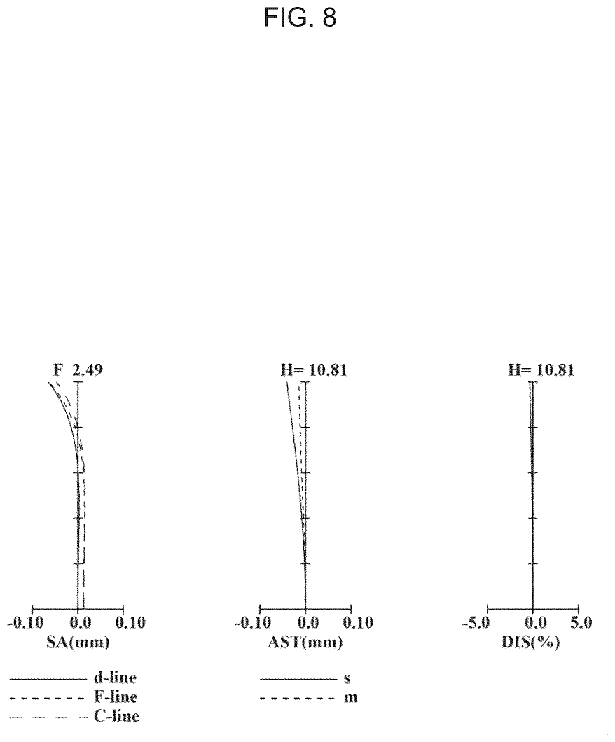

FIG. 8 is an aberration diagram illustrating various aberrations in projection optical system 60A according to Example 1. Note that the aberration diagrams indicated in each of FIGS. 8, 10, and 12 presents various aberrations while the entire corresponding projection optical system is in focus.

FIG. 8 includes a spherical aberration diagram plotting the spherical aberration on horizontal axis “SA (mm)”; an astigmatism diagram plotting the astigmatism on horizontal axis “AST (mm)”; and a distortion aberration diagram plotting the distortion aberration on horizontal axis “DIS (%)”, in the order described herein from the left.

In each spherical aberration diagram, vertical axis “F” represents an f-number. The solid line denoted as “d-line” in the diagrams indicates properties of a d-line. A broken line denoted by “F-line” indicates properties of an F-line. A broken line denoted by “C-line” indicates properties of a C-line. In each of the astigmatism diagrams and the distortion aberration diagrams, vertical axis “H” denotes an image height. The solid line denoted by “s” in the diagrams indicates properties of a sagittal plane. The broken line denoted by “i” indicates properties of a meridional plane.

Provided now is parameter data 1 corresponding to projection optical system 60A according to Example 1. In parameter data 1, Table 1-1 provides surface data, Table 1-2 provides various types of data, and Table 1-3 provides single lens data. Table 1-1 provides data on each of lens surfaces of the lens elements included in projection optical system 60A, and includes curvature radius r, surface interval d, refractive index nd, and Abbe number vd of the lens surface. Tables 1-2 and 1-3 correspond to a light wavelength of 550 nm.

### (Parameter Data 1)

TABLE 1-1

| Surface number | r (mm) | d (mm) | nd | vd |
|---|---|---|---|---|
| Object plane | ∞ | | | |
| 1 | ∞ | 9.50000 | | |
| 2 | 83.84990 | 2.50000 | 1.78472 | 25.7 |
| 3 | 41.43770 | 3.00000 | | |
| 4 | 43.00620 | 15.00000 | 1.77250 | 49.6 |
| 5 | −339.44220 | 1.01450 | | |
| 6 | −343.44600 | 2.50000 | 1.49700 | 81.6 |
| 7 | 37.02500 | 4.83230 | | |
| 8 | 88.05300 | 5.73600 | 1.49700 | 81.6 |
| 9 | 44.09690 | 18.71820 | | |
| 10 | 201.40840 | 2.00000 | 1.45860 | 90.3 |
| 11 | 50.73390 | 0.30000 | | |
| 12 | 39.49580 | 3.50030 | 1.69895 | 30.0 |
| 13 | 62.61860 | 3.50000 | | |
| 14 | 68.38700 | 2.00000 | 1.48749 | 70.4 |
| 15 | 41.32900 | 15.08000 | | |
| 16 | ∞ | 15.08000 | | |
| 17 | 197.38000 | 3.20000 | 1.69895 | 30.0 |
| 18 | −197.38000 | 0.00000 | | |
| 19 (iris diaphragm) | ∞ | 22.75000 | | |
| 20 | −62.80400 | 5.00000 | 1.48749 | 70.4 |
| 21 | 111.20000 | 4.33000 | | |
| 22 | 234.97000 | 9.00000 | 1.49700 | 81.6 |
| 23 | −110.81000 | 4.00000 | | |
| 24 | 935.66000 | 9.28000 | 1.49700 | 81.6 |
| 25 | −50.58000 | 4.47000 | | |
| 26 | −49.13600 | 7.20000 | 1.58144 | 40.9 |
| 27 | −79.00000 | 9.54430 | | |
| 28 | 108.00000 | 9.95000 | 1.45860 | 90.3 |
| 29 | −108.00000 | 1.00000 | | |
| 30 | 2027.00000 | 2.20000 | 1.83400 | 37.3 |
| 31 | 72.04400 | 5.80000 | | |
| 32 | 163.73000 | 9.50000 | 1.49700 | 81.6 |
| 33 | −93.00000 | 0.70000 | | |
| 34 | −80.37200 | 2.20000 | 1.51742 | 52.1 |
| 35 | −148.58000 | 0.20000 | | |
| 36 | 81.30000 | 9.08000 | 1.45860 | 90.3 |
| 37 | −354.92000 | 14.52860 | | |
| 38 | ∞ | 91.00000 | 1.51680 | 64.2 |
| 39 | ∞ | 1.00000 | | |
| 40 | ∞ | 1.00000 | 1.47401 | 65.4 |
| 41 | ∞ | 1.00000 | | |
| 42 | ∞ | 3.00000 | 1.50847 | 61.2 |
| 43 | ∞ | 1.00000 | | |
| 44 | ∞ | −2.73590 | | |
| Image plane | ∞ | | | |

TABLE 1-2

| | |
|---|---|
| Focal distance (mm) | 51.3976 |
| F-number | 2.4767 |
| Angle of view (deg.) | 11.9258 |
| Image height (mm) | 10.8150 |
| Total lens length (mm) | 340.7984 |
| BF (mm) | −2.71916 |
| Position of entrance pupil (mm) | 82.6762 |
| Position of exit pupil (mm) | 1963.7766 |
| Position of front-side principal point (mm) | 135.4253 |
| Position of back-side principal point (mm) | 288.9184 |

TABLE 1-3

| Lens | First Surface | Focal distance (mm) |
|---|---|---|
| 1 | 2 | −107.1759 |
| 2 | 4 | 50.2705 |
| 3 | 6 | −67.1014 |
| 4 | 8 | −185.7864 |
| 5 | 10 | −148.4972 |
| 6 | 12 | 144.0555 |
| 7 | 14 | −219.5924 |
| 8 | 17 | 141.6700 |
| 9 | 20 | −81.5637 |
| 10 | 22 | 152.8293 |
| 11 | 24 | 96.8543 |
| 12 | 26 | −245.2928 |
| 13 | 28 | 119.4801 |
| 14 | 30 | −89.6129 |
| 15 | 32 | 120.8228 |
| 16 | 34 | −342.1287 |
| 17 | 36 | 145.1888 |

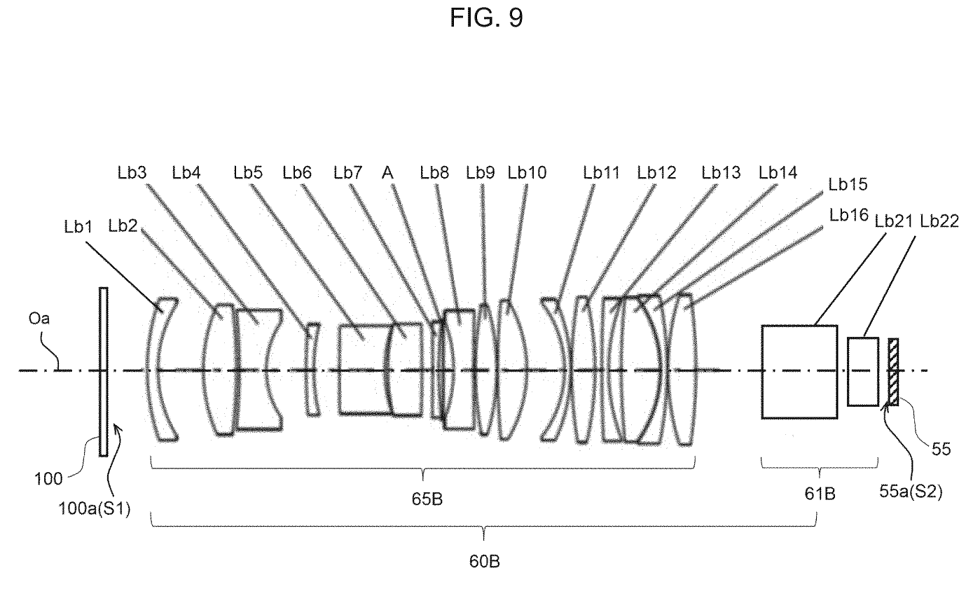

FIG. 9 is a lens arrangement diagram of projection optical system 60B according to Example 2. Projection optical system 60B in FIG. 9 includes back glass member 61B and lens unit 65B. Unlike projection optical system 60A in FIG. 7, lens unit 65B includes first to sixteenth lens elements Lb1 to Lb16 arranged side by side. Each of first to sixteenth lens elements Lb1 to Lb16 is provided as a positive lens or a negative lens. Diaphragm A is disposed on the reducing side of seventh lens element Lb7. Back glass member 61B includes various prisms, filters, and cover glasses, for example. Back glass members Lb21, Lb22 for image plane S2, which corresponds to display surface 55a of video display element 55, are conceptually illustrated in FIG. 9.

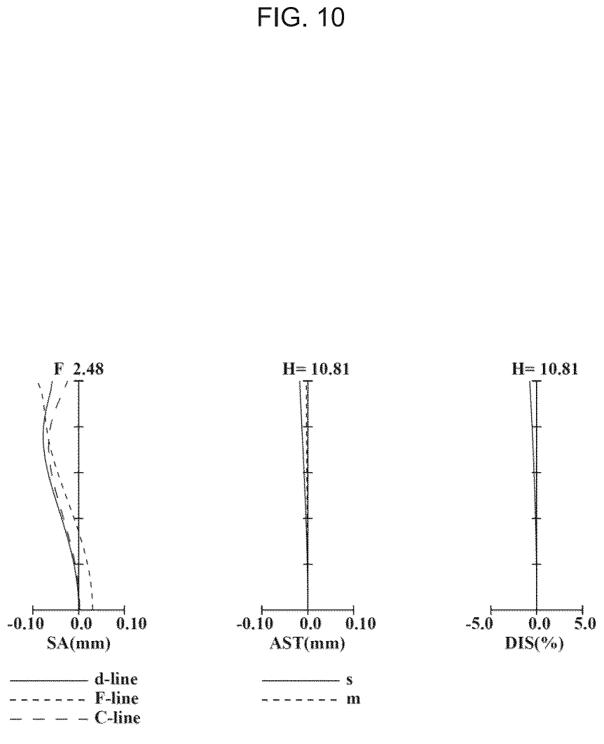

FIG. 10 is an aberration diagram illustrating various aberrations in projection optical system 60B according to Example 2. The aberration diagram includes a spherical aberration diagram plotting the spherical aberration on horizontal axis “SA (mm)”; an astigmatism diagram plotting the astigmatism on horizontal axis “AST (mm)”; and a distortion aberration diagram plotting the distortion aberration on horizontal axis “DIS (%)”, in the order described herein from the left. The spherical aberration diagram, the astigmatism diagram, and the distortion diagram indicate the properties using the same reference signs as those in FIG. 8. Therefore, a detailed description thereof is omitted herein.

Provided now is parameter data 2 corresponding to projection optical system 60B according to Example 2. In parameter data 2, Table 2-1 provides surface data, Table 2-2 provides various types of data, and Table 2-3 provides single lens data. Table 2-1 provides data on each of the lens surfaces of the lens elements included in projection optical system 60B, and includes curvature radius r, surface interval d, refractive index nd, and Abbe number vd of the lens surface. Tables 2-2 and 2-3 correspond to a light wavelength of 550 nm.

### (Parameter Data 2)

TABLE 2-1

| Surface number | r (mm) | d (mm) | nd | vd |
|---|---|---|---|---|
| Object plane | ∞ | | | |
| 1 | ∞ | 9.50000 | | |
| 2 | 69.30540 | 3.50000 | 1.78472 | 25.7 |
| 3 | 40.99650 | 14.75400 | | |
| 4 | 51.86590 | 10.76070 | 1.77250 | 49.6 |
| 5 | −170.88190 | 1.00000 | | |
| 6 | −195.82520 | 8.76260 | 1.49700 | 81.6 |
| 7 | 27.34790 | 12.96710 | | |
| 8 | 188.89110 | 2.50000 | 1.49700 | 81.6 |
| 9 | 61.96670 | 8.36730 | | |
| 10 | 1523.92930 | 14.75490 | 1.45860 | 90.3 |
| 11 | 43.69300 | 0.98060 | | |
| 12 | 63.42910 | 11.08970 | 1.69895 | 30.0 |
| 13 | −536.45870 | 3.50000 | | |
| 14 | −1069.61200 | 2.00000 | 1.48749 | 70.4 |
| 15 | 144.82390 | 1.08540 | | |
| 16 | ∞ | 0.30000 | | |
| 17 | ∞ | 0.40000 | | |
| 18 (iris diaphragm) | ∞ | 3.06780 | | |
| 19 | −44.83030 | 6.46010 | 1.48749 | 70.4 |
| 20 | 725.82910 | 0.66300 | | |
| 21 | 116.27360 | 7.01530 | 1.49700 | 81.6 |
| 22 | −74.00310 | 0.30000 | | |
| 23 | 246.44540 | 9.50360 | 1.49700 | 81.6 |
| 24 | −44.79610 | 12.25370 | | |
| 25 | −35.80110 | 2.00000 | 1.58144 | 40.9 |
| 26 | −55.01190 | 0.30000 | | |
| 27 | 138.79090 | 7.60840 | 1.45860 | 90.3 |
| 28 | −104.31500 | 2.21930 | | |
| 29 | 465.37050 | 2.22210 | 1.83400 | 37.3 |
| 30 | 62.85610 | 4.10840 | | |
| 31 | 223.67360 | 12.61550 | 1.49700 | 81.6 |
| 32 | −40.00560 | 0.30000 | | |
| 33 | −40.55440 | 2.00000 | 1.51742 | 52.1 |
| 34 | −119.20600 | 0.30000 | | |
| 35 | 81.05670 | 9.12330 | 1.45860 | 90.3 |
| 36 | −169.99620 | 18.77560 | | |
| 37 | ∞ | 91.00000 | 1.51680 | 64.2 |
| 38 | ∞ | 1.00000 | | |
| 39 | ∞ | 1.00000 | 1.47401 | 65.4 |
| 40 | ∞ | 1.00000 | | |
| 41 | ∞ | 3.00000 | 1.50847 | 61.2 |
| 42 | ∞ | 1.00000 | | |
| 43 | ∞ | −5.22450 | | |
| Image plane | ∞ | | | |

TABLE 2-2

| | |
|---|---|
| Focal distance (mm) | 51.4674 |
| F-number | 2.4767 |
| Angle of view (deg.) | 11.9314 |
| Image height (mm) | 10.8150 |
| Total lens length (mm) | 299.9012 |
| BF (mm) | −5.15724 |
| Position of entrance pupil (mm) | 73.9116 |
| Position of exit pupil (mm) | −253.0477 |
| Position of front-side principal point (mm) | 114.6776 |
| Position of back-side principal point (mm) | 247.9477 |

TABLE 2-3

| Lens | First Surface | Focal distance (mm) |
|---|---|---|
| 1 | 2 | −135.2543 |
| 2 | 4 | 52.6147 |
| 3 | 6 | −47.6620 |
| 4 | 8 | −186.7755 |
| 5 | 10 | −98.3954 |
| 6 | 12 | 81.7757 |
| 7 | 14 | −261.5124 |
| 8 | 20 | −86.3747 |
| 9 | 22 | 92.1171 |
| 10 | 24 | 77.1053 |
| 11 | 26 | −183.3381 |
| 12 | 28 | 131.1514 |
| 13 | 30 | −87.3555 |
| 14 | 32 | 69.3840 |
| 15 | 34 | −119.8305 |
| 16 | 36 | 121.0653 |

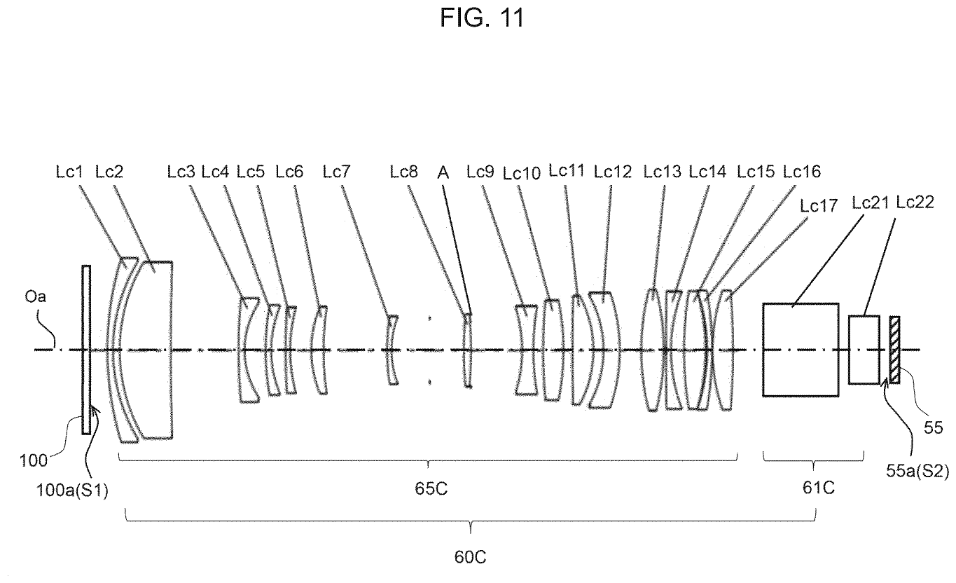

FIG. 11 is a lens arrangement diagram of projection optical system 60C according to Comparative Example 1. Projection optical system 60C in FIG. 11 includes back glass member 61C and lens unit 65C. Lens unit 65C includes first to seventeen lens elements Lc1 to Lc17 arranged side by side, and each of the first to seventeenth lens elements Lc1 to Lc17 is configured as a positive lens or a negative lens. Diaphragm A is disposed on the reducing side of eighth lens element Lc8. Back glass member 61C includes various prisms, filters, and cover glasses, for example. Back glass members Lc21, Lc22 for image plane S2, which corresponds to display surface 55a of video display element 55, are conceptually illustrated in FIG. 11.

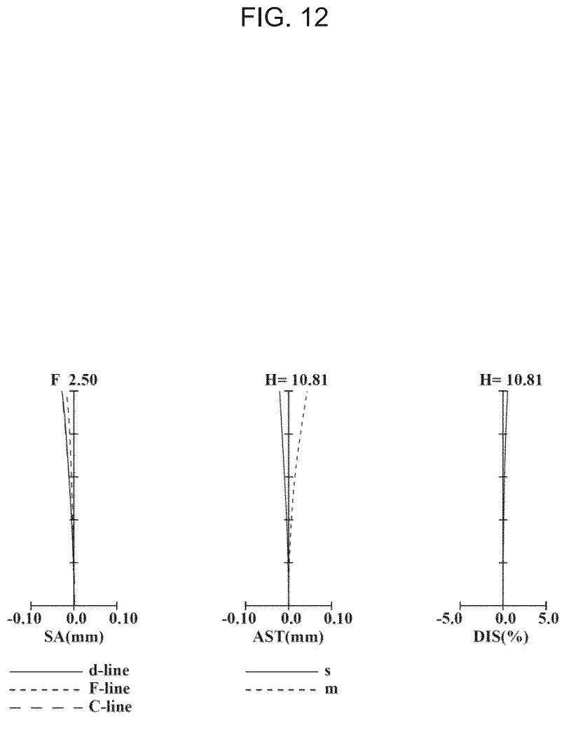

FIG. 12 is an aberration diagram illustrating various aberrations in projection optical system 60C according to Comparative Example 1. The aberration diagram includes a spherical aberration diagram plotting the spherical aberration on horizontal axis “SA (mm)”; an astigmatism diagram plotting the astigmatism on horizontal axis “AST (mm)”; and a distortion aberration diagram plotting the distortion aberration on horizontal axis “DIS (%)”, in the order described herein from the left. The spherical aberration diagram, the astigmatism diagram, and the distortion diagram indicate the properties using the same reference signs as those in FIG. 8. Therefore, a detailed description thereof is omitted herein.

Provided now is parameter data 3 corresponding to projection optical system 60C according to Comparative Example 1. In parameter data 3, Table 3-1 provides surface data, Table 3-2 provides various types of data, and Table 3-3 provides single lens data. Table 3-1 provides data on each of the lens surfaces of the lens elements included in projection optical system 60C, and includes curvature radius r, surface interval d, refractive index nd, and Abbe number vd of the lens surface. Tables 3-2 and 3-3 correspond to a light wavelength of 550 nm.

### (Parameter Data 3)

TABLE 3-1

| Surface number | r (mm) | d (mm) | nd | vd |
|---|---|---|---|---|
| Object plane | ∞ | | | |
| 1 | ∞ | 9.50000 | | |
| 2 | 138.14430 | 2.50000 | 1.80518 | 25.5 |
| 3 | 75.57290 | 3.00000 | | |
| 4 | 76.88780 | 22.66750 | 1.77250 | 49.6 |
| 5 | 1185.52890 | 30.00000 | | |
| 6 | 249.67880 | 2.68060 | 1.49663 | 79.1 |
| 7 | 38.07470 | 9.32040 | | |
| 8 | 113.58290 | 2.50000 | 1.47225 | 79.5 |
| 9 | 50.47820 | 6.36100 | | |
| 10 | 374.16860 | 2.00000 | 1.47697 | 84.0 |
| 11 | 70.42970 | 9.38930 | | |
| 12 | 49.76600 | 5.44210 | 1.72745 | 45.2 |
| 13 | 122.26540 | 28.13180 | | |
| 14 | 92.43290 | 2.00000 | 1.49006 | 80.7 |
| 15 | 40.49360 | 16.99430 | | |
| 16 | ∞ | 15.08000 | | |
| 17 | 197.38000 | 3.20000 | 1.69895 | 30.0 |
| 18 | −197.38000 | 0.00000 | | |
| 19 (iris diaphragm) | ∞ | 22.75000 | | |
| 20 | −62.80400 | 5.00000 | 1.48749 | 70.4 |
| 21 | 111.20000 | 4.33000 | | |
| 22 | 234.97000 | 9.00000 | 1.49700 | 81.6 |
| 23 | −110.81000 | 4.00000 | | |
| 24 | 935.66000 | 9.28000 | 1.49700 | 81.6 |
| 25 | −50.58000 | 4.47000 | | |
| 26 | −49.13600 | 7.20000 | 1.58144 | 40.9 |
| 27 | −79.00000 | 9.54430 | | |
| 28 | 108.00000 | 9.95000 | 1.45860 | 90.3 |
| 29 | −108.00000 | 1.00000 | | |
| 30 | 2027.00000 | 2.20000 | 1.83400 | 37.3 |
| 31 | 72.04400 | 5.80000 | | |
| 32 | 163.73000 | 9.50000 | 1.49700 | 81.6 |
| 33 | −93.00000 | 0.70000 | | |
| 34 | −80.37200 | 2.20000 | 1.51742 | 52.1 |
| 35 | −148.58000 | 0.20000 | | |
| 36 | 81.30000 | 9.08000 | 1.45860 | 90.3 |
| 37 | −354.92000 | 14.52860 | | |
| 38 | ∞ | 91.00000 | 1.51680 | 64.2 |
| 39 | ∞ | 1.00000 | | |
| 40 | ∞ | 1.00000 | 1.47401 | 65.4 |
| 41 | ∞ | 1.00000 | | |
| 42 | ∞ | 3.00000 | 1.50847 | 61.2 |
| 43 | ∞ | 1.00000 | | |
| 44 | ∞ | 0.02918 | | |
| Image plane | ∞ | | | |

TABLE 3-2

| | |
|---|---|
| Focal distance (mm) | 50.8493 |
| F-number | 2.4767 |
| Angle of view (deg.) | 11.9464 |
| Image height (mm) | 10.8150 |
| Total lens length (mm) | 399.5300 |
| BF (mm) | 0.03010 |
| Position of entrance pupil (mm) | 158.3305 |
| Position of exit pupil (mm) | 1971.1000 |
| Position of front-side principal point (mm) | 210.4999 |
| Position of back-side principal point (mm) | 348.2144 |

TABLE 3-3

| Lens | First Surface | Focal distance (mm) |
|---|---|---|
| 1 | 2 | −210.9789 |
| 2 | 4 | 105.4939 |
| 3 | 6 | −90.8434 |
| 4 | 8 | −194.8650 |
| 5 | 10 | −182.2857 |
| 6 | 12 | 111.8357 |
| 7 | 14 | −148.9368 |
| 8 | 17 | 141.6700 |
| 9 | 20 | −81.5637 |
| 10 | 22 | 152.8293 |
| 11 | 24 | 96.8543 |
| 12 | 26 | −245.2928 |
| 13 | 28 | 119.4801 |
| 14 | 30 | −89.6129 |
| 15 | 32 | 120.8228 |
| 16 | 34 | −342.1287 |
| 17 | 36 | 145.1888 |

### (Satisfactions of Conditions (1) to (3) by Projection Optical Systems According to Examples and Comparative Example)

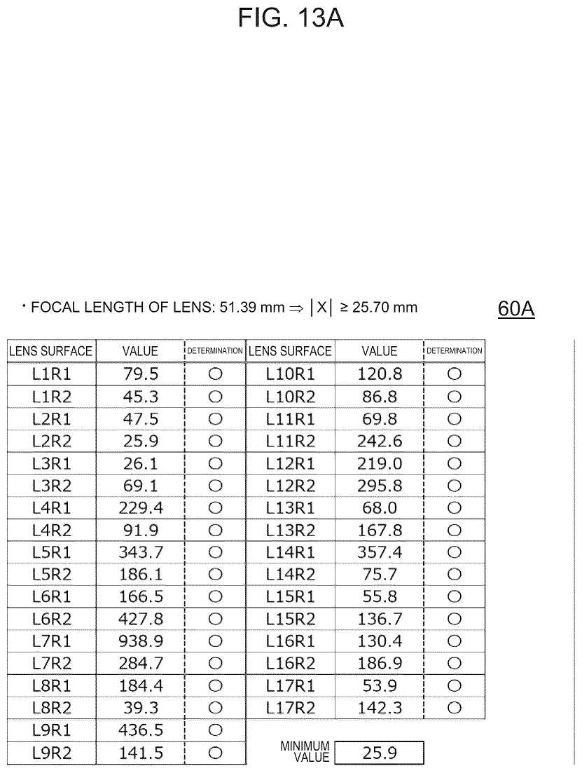

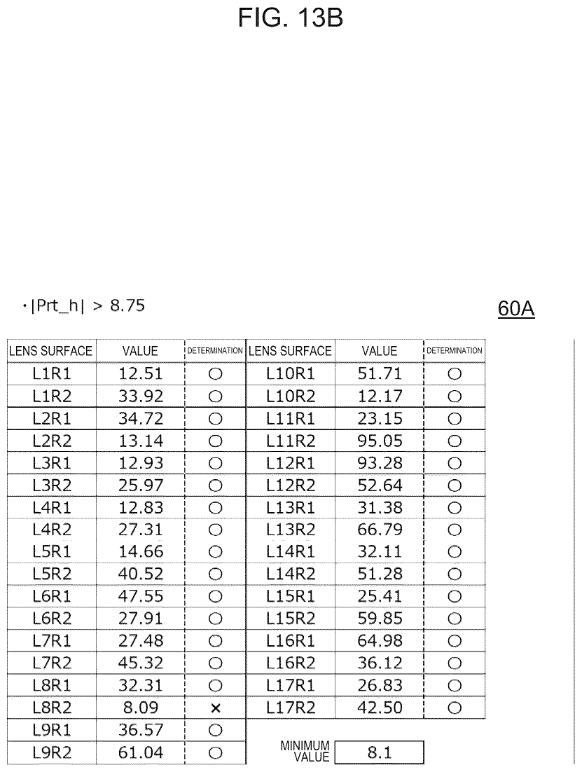

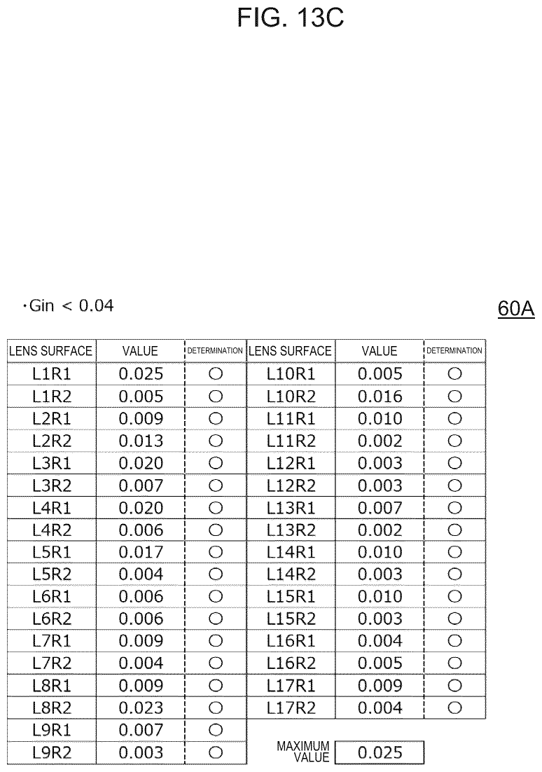

FIGS. 13A, 13B, and 13C provide results of determining, by ray tracing, how each of the lens surfaces of first to seventeenth lens elements La1 to La17 in lens unit 65A of projection optical system 60A illustrated in FIG. 7 satisfied conditions (1) to (3), respectively. The symbol “◯” indicates a determination that the corresponding condition was satisfied, and the symbol “X” indicates a determination that the corresponding condition was not satisfied.

Specifically, FIG. 13A is a table indicating how condition (1) was satisfied by projection optical system 60A according to Example 1. As indicated in Table 1-2, the focal length of entire projection optical system 60A according to Example 1 was determined as about 51.39 mm, and condition (1) was determined as |X|≥25.7 mm. Because 25.9 mm was the minimum value of |X|, among those of lens surfaces L1R1 to L17R2 of lens elements La1 to La17, every one of the lens surfaces in projection optical system 60A satisfied condition (1).

FIG. 13B is a table indicating how condition (2) was satisfied by projection optical system 60A according to Example 1. In this example, the length D, which is a half the diagonal length of display surface 55a (see FIG. 7) of the video display element, was 8.75 mm, and the spot size index in condition (2) was determined as |Prt_h|>8.75. Furthermore, as indicated in Table 1-2, the focal length of entire projection optical system 60A according to Example 1 was about 51.39 mm, and the f-number was 2.4787. Every one of the lens surfaces lens surfaces L1R1 to L17R2 of lens elements La1 to La17, except for lens surface L8R2 of the eighth lens element, satisfied condition (2). Because lens surface L8R2 of the eighth lens element exhibited a value |Prt_h| of 8.09, lens surface L8R2 did not satisfy condition (2).

FIG. 13C is a table indicating how condition (3) was satisfied by projection optical system 60A according to Example 1. The ghost index for condition (3) was determined as Gin<0.04. Because ghost index Gin took the maximum value of 0.025, among those of lens surfaces L1R1 to L17R2 of lens elements La1 to La17, every one of the lens surfaces in projection optical system 60A satisfied condition (3).

As described above, it has been found out that every one of lens surfaces L1R1 to L17R2 in projection optical system 60A according to Example 1 satisfied at least one of conditions (1) to (3).

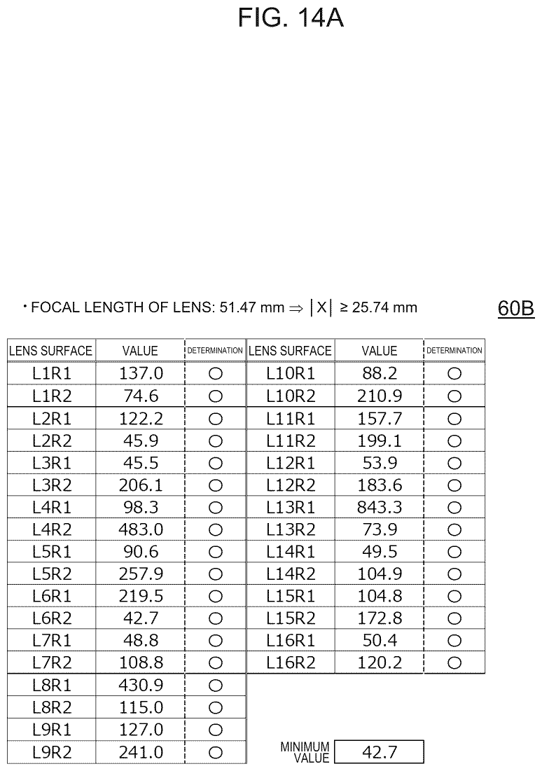

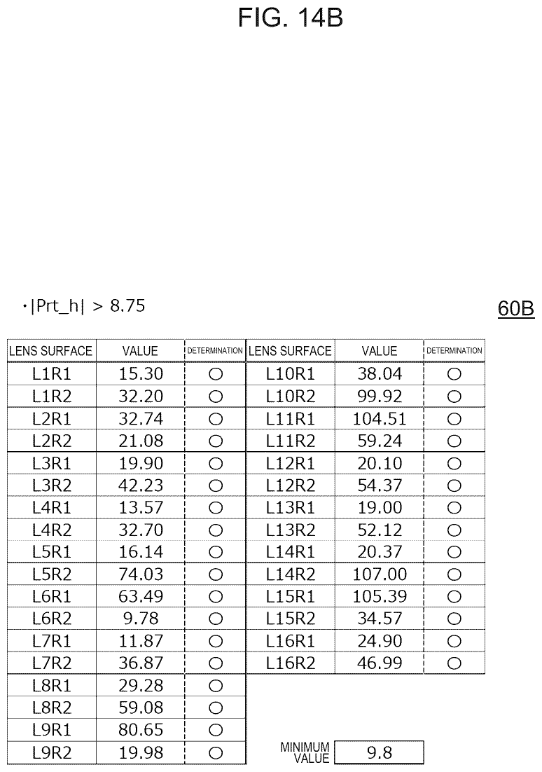

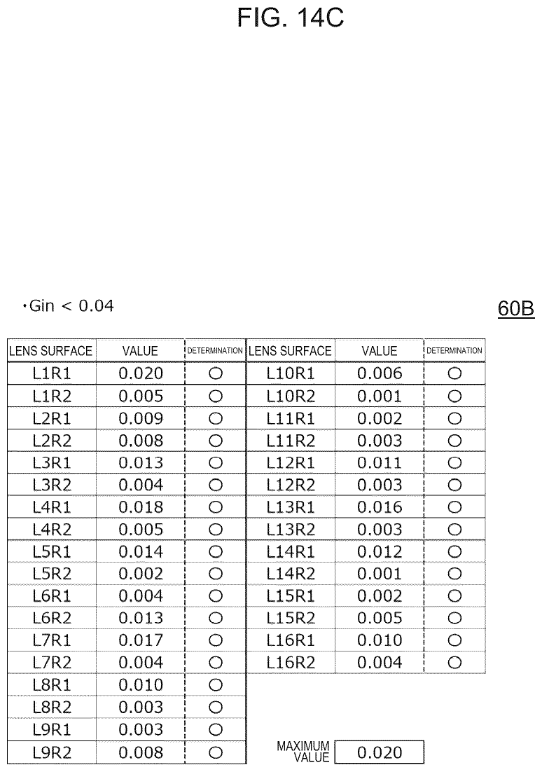

FIGS. 14A, 14B, and 14C provide results of determining, by ray tracing, how each of the lens surfaces of first to sixteenth lens elements Lb1 to Lb16 in lens unit 65B of projection optical system 60B illustrated in FIG. 9 satisfied conditions (1) to (3), respectively. The symbol “◯” indicates a determination that the corresponding condition was satisfied, and the symbol “X” indicates a determination that the corresponding condition was not satisfied.

Specifically, FIG. 14A is a table indicating how condition (1) was satisfied by projection optical system 60B according to Example 2. As indicated in Table 2-2, the focal length of entire projection optical system 60B according to Example 2 was determined as about 51.47 mm, and condition (1) was determined as |X|≥25.74. Because 42.7 mm was the minimum value of |X|, among those of lens surfaces L1R1 to L16R2 of lens elements Lb1 to Lb16, every one of the lens surfaces in projection optical system 60B satisfied condition (1).

FIG. 14B is a table indicating how condition (2) was satisfied by projection optical system 60B according to Example 2. In this example, the length D, which is a half the diagonal length of display surface 55a (see FIG. 7) of the video display element, was 8.75 mm, and the spot size index in condition (2) was determined as |Prt_h|>8.75. Because 9.8 was the minimum value of spot size index |Prt_h|, among those of lens surfaces L1R1 to L16R2 of lens elements Lb1 to Lb16, every one of the lens surfaces in projection optical system 60B satisfied condition (2).

FIG. 14C is a table indicating how condition (3) was satisfied by projection optical system 60B according to Example 2. The ghost index for condition (3) was determined as Gin<0.04. Because ghost index Gin took the maximum value of 0.020, among those of lens surfaces L1R1 to L16R2 of lens elements Lb1 to Lb16, every one of the lens surfaces in projection optical system 60B satisfied condition (3).

As described above, it has been found out that every one of lens surfaces L1R1 to L16R2 in projection optical system 60B according to Example 2 satisfied all of conditions (1) to (3).

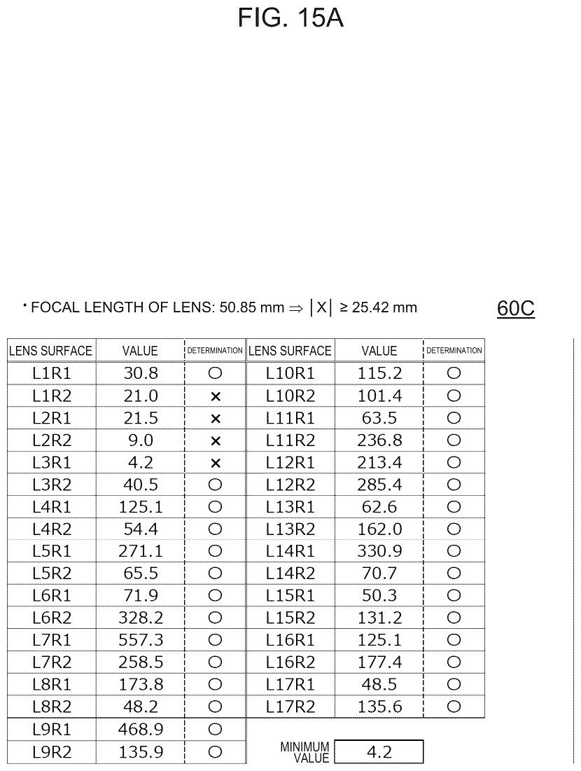

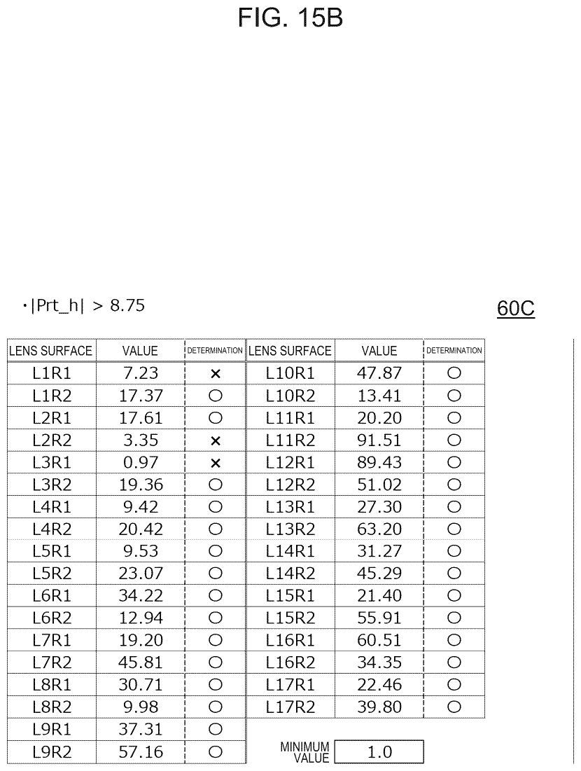

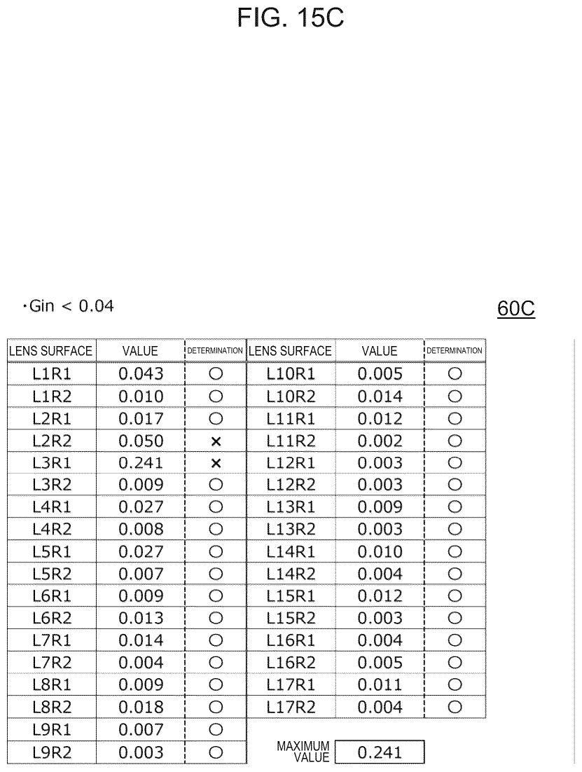

FIGS. 15A, 15B, and 15C provide results of determining, by ray tracing, how each of the lens surfaces of first to seventeenth lens elements Lc1 to Lc17 in lens unit 65C of projection optical system 60C illustrated in FIG. 11 satisfied conditions (1) to (3), respectively. The symbol “◯” indicates a determination that the corresponding condition was satisfied, and the symbol “X” indicates a determination that the corresponding condition was not satisfied.

Specifically, FIG. 15A is a table indicating how condition (1) was satisfied by projection optical system 60C according to Comparative Example 1. As indicated in Table 3-2, the focal length of entire projection optical system 60C according to Comparative Example 1 was determined as about 50.85 mm, and condition (1) was determined as |X|≥25.42 mm. The minimum value of |X| was 4.2 mm, among those of the lens surfaces L1R1 to L17R2 of lens elements Lc1 to Lc17. As indicated in FIG. 15A, in projection optical system 60C according to Comparative Example 1, lens surface L1R2 of first lens element Lc1, lens surfaces L2R1, L2R2 of second lens element Lc2, and lens surface L3R1 of third lens element Lc3 were found not to satisfy condition (1).

FIG. 15B is a table indicating how condition (2) was satisfied by projection optical system 60C according to Comparative Example 1. In this example, the length D, which is a half the diagonal length of display surface 55a (see FIG. 7) of the video display element, was 8.75 mm, and the spot size index in condition (2) was determined as |Prt_h|>8.75. The minimum value of spot size index |Prt_h| was 1.0, among those of the lens surfaces L1R1 to L17R2 of lens elements Lc1 to Lc17. As indicated in FIG. 15B, in projection optical system 60C according to Comparative Example 1, lens surface L1R1 of first lens element Lc1, lens surfaces L2R2 of second lens element Lc2, and lens surface L3R1 of third lens element Lc3 were found not to satisfy condition (2).

FIG. 15C is a table indicating how condition (3) was satisfied by projection optical system 60C according to Comparative Example 1. The ghost index for condition (3) was determined as Gin<0.04. The maximum value of ghost index Gin was 0.241, among those of the lens surfaces L1R1 to L17R2 of lens elements Lc1 to Lc17. As indicated in FIG. 15C, in projection optical system 60C according to Comparative Example 1, lens surfaces L2R2 of second lens element Lc2 and lens surface L3R1 of third lens element Lc3 were found not to satisfy condition (3).

In the manner described above, among lens surfaces L1R1 to L17R2 in projection optical system 60C according to Comparative Example 1, lens surface L2R2 of second lens element Lc2 and lens surface L3R1 of third lens element Lc3 were found to satisfy none of conditions (1) to (3).

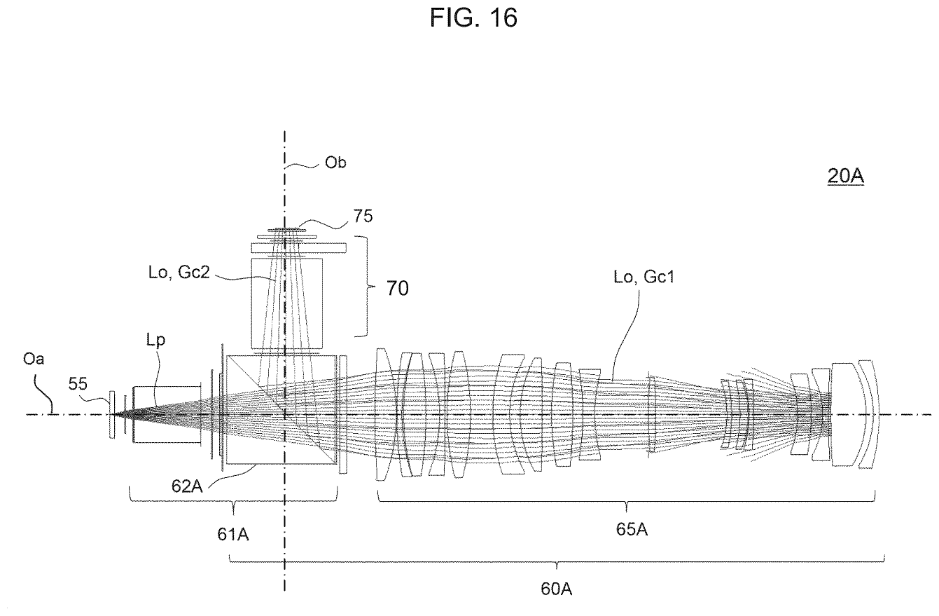

Described below with reference to FIGS. 16 to 19 is how formation of a ghost image due to the light reflecting on the lens surfaces can be suppressed, by configuring the projection optical system to have the lens surfaces of the lens elements satisfying conditions (1) to (3).

### (Suppression of Ghost Image Formation by Light Reflected on Lens Surface)

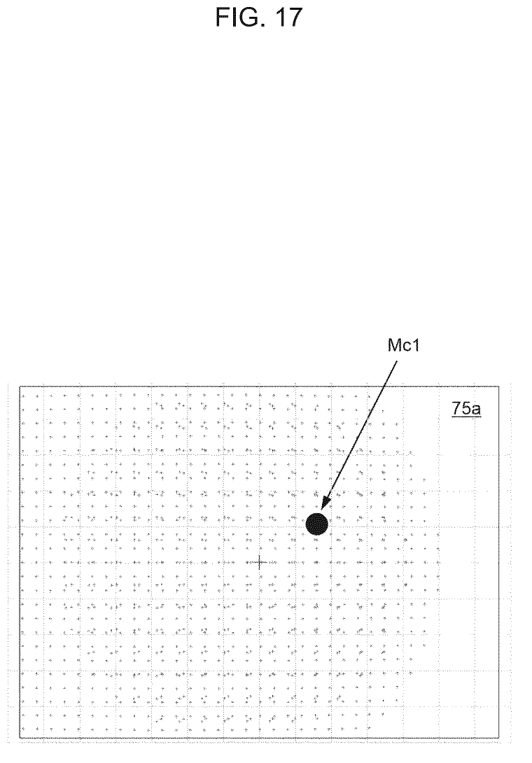

FIG. 16 is a diagram illustrating propagation of light in propagation optical system 20A that uses projection optical system 60A according to Example 1. FIG. 17 is a diagram illustrating an image formed by propagation optical system 20A illustrated in FIG. 16.

Propagation optical system 20A illustrated in FIG. 16 includes projection optical system 60A according to Example 1 and imaging optical system 70. Projection light Lp was output from video display element 55, passed through projection optical system 60A toward the right in the drawing along optical axis Oa, and was magnified and projected onto projection target 100 (not illustrated). External light Lo passed through projection optical system 60A toward the left in the drawing, guided into imaging optical system 70, and formed an image on the imaging surface of imaging element 75.

When projection light Lp passed through lens unit 65A in projection optical system 60A, projection light Lp was reflected on the lens surfaces of the plurality of lens elements, to form reflected light Gc1 propagating toward video display element 55. Reflected light Gc1 from the lens surface was reflected again on separation prism 62A, so that ghost light Gc2 became incident on imaging optical system 70 along optical axis Ob.

As illustrated in FIGS. 13A to 13C, every one of lens surfaces L1R1 to L17R2 in projection optical system 60A according to Example 1 satisfied at least one of conditions (1) to (3). With projection optical system 60A configured as described above, because the lens surface satisfies condition (3) when reflected light Gc1 from the lens surface propagates toward video display element 55, a large portion of light deviated from the optical path, so that the light intensity of ghost light Gc2 reaching imaging optical system 70 became reduced.

In addition, because the lens surfaces satisfy condition (2), there was no formation of partial convergence by ghost light Gc2 in propagation optical system 20A. Furthermore, because the lens surfaces satisfy condition (1), the focal depth of the image formed by ghost light Gc2 incident on imaging optical system 70 was offset from the imaging surface of imaging element 75.

In the manner described above, as illustrated in FIG. 17, while enabling captured image Mc1 resultant of external light Lo to be clearly formed on imaging surface 75a of imaging element 75, formation of a ghost image by ghost light Gc2 was eliminated successfully. As a result, a decrease in the contrast caused by a ghost image in a captured image was suppressed successfully, and the image quality of the projection display apparatus was improved successfully.

Although propagation optical system 20A in FIG. 16 is a configuration example of the propagation optical system using projection optical system 60A according to Example 1, the same kind of effects were achieved successfully in a propagation optical system using projection optical system 60B according to Example 2. Furthermore, although the improvement in the image quality of the captured image on the imaging surface of the imaging element is illustrated in FIG. 17 as an example, the contrast of the video on the projection surface (not illustrated), too, was improved successfully.

Furthermore, the improvement of the image quality of the projection display apparatus by the projection optical system configured to satisfy conditions (1) to (3) has been described using an example of propagation optical system 20A including imaging optical system 70, but the present disclosure is not limited thereto. For example, even in propagation optical system 20a not having imaging optical system illustrated in FIG. 2, it is needless to say that the contrast of the video on the projection surface and the image quality of the video can be improved by mounting projection optical systems 60A, 60B in which every one of the lens surfaces satisfies at least one of conditions (1) to (3), or in which every one of the lens surfaces satisfies all conditions (1) to (3).

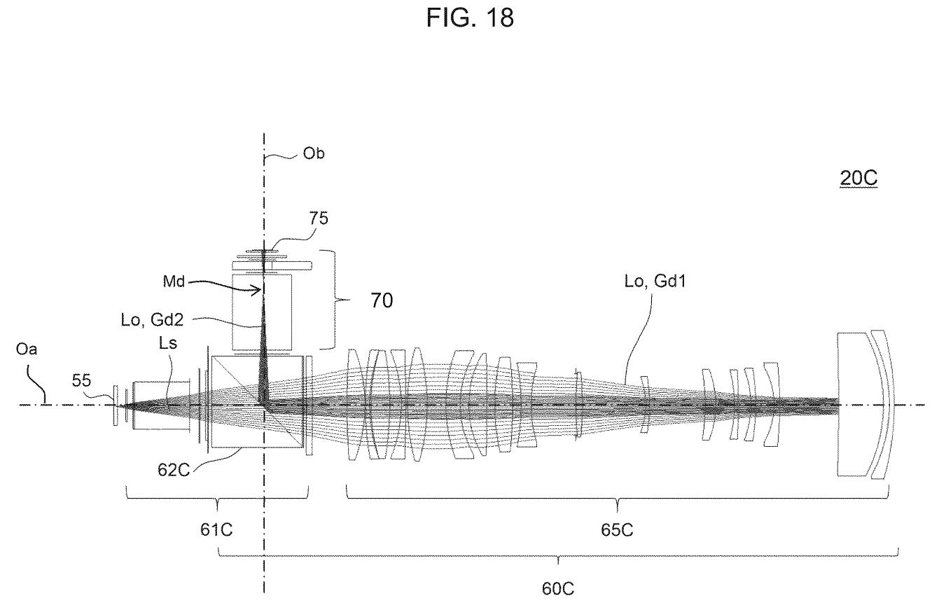

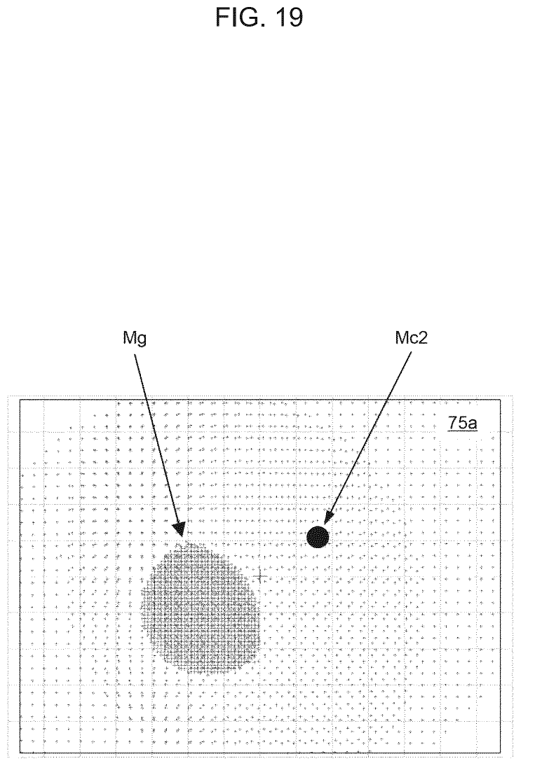

FIG. 18 is a diagram illustrating propagation of light in propagation optical system 20C that uses projection optical system 60C according to Comparative Example 1. FIG. 19 is a diagram illustrating an image formed by propagation optical system 20C illustrated in FIG. 18.

Propagation optical system 20C illustrated in FIG. 18 includes projection optical system 60C according to the first example and imaging optical system 70. Projection light Lp was output from video display element 55, passed through projection optical system 60C toward the right in the drawing along optical axis Oa, and was magnified and projected onto projection target 100 (not illustrated). External light Lo passed through projection optical system 60C toward the left in the drawing, guided into imaging optical system 70, and formed an image on the imaging surface of imaging element 75.

When projection light Lp passed through lens unit 65C in projection optical system 60C, projection light Lp was reflected on the lens surfaces of the plurality of lens elements, and formed reflected light Gd1 propagating toward video display element 55. Reflected light Gd1 from the lens surfaces was then reflected again on separation prism 62C, so that ghost light Gd2 became incident on imaging optical system 70 along optical axis Ob.

As illustrated in FIGS. 15A to 15C, among lens surfaces L1R1 to L17R2 in projection optical system 60C according to Comparative Example 1, lens surface L2R2 of second lens element Lc2 and lens surface L3R1 of third lens element Lc3 satisfied none of conditions (1) to (3). With projection optical system 60C configured as described above, as illustrated in FIG. 18, when reflected light Gd1 from the lens surface propagated toward video display element 55, only a small portion of light deviated from the optical path, and most of reflected light Gd1 from the lens surfaces became incident on imaging optical system 70 as ghost light Gd2. In addition, the partial convergence of the rays of ghost light Gd2 formed intermediate image Md in imaging optical system 70, and then formed a ghost image on the imaging surface of imaging element 75.

As illustrated in FIG. 19, highly intense ghost image Mg was formed on imaging surface 75a of imaging element 75 by ghost light Gc2, near captured image Mc2 formed by external light Lo. This resulted in a reduced contrast of the captured image, and a deterioration of the image quality.

Note that, in FIG. 19, a deterioration of the image quality of the image captured on the imaging surface of the imaging element has been described as an example, but the contrast of the video on the projection surface (not illustrated), too, deteriorated.

As described above, one exemplary embodiment has been described above as an example of the technology disclosed in the present application. However, the technologies according to the present disclosure are not limited to the above exemplary embodiment, and may also be applied to exemplary embodiments in which change, substitution, addition, omission, and the like are made. Furthermore, it is also possible to make a new exemplary embodiment by combining the elements described in each of the exemplary embodiments.

In addition, the accompanying drawings and the detailed description have been provided for the purpose of describing the exemplary embodiment. Thus, the components illustrated in the accompanying drawings and described in the detailed description may include not only the components essential for solving the problem, but also components that are not essential for solving the problem, as illustrative examples of the technology described above. Therefore, such non-essential components should not be immediately construed as essential merely on the basis of the fact that those non-essential components are illustrated in the accompanying drawings or described in the detailed descriptions.

Note that the exemplary embodiment described above is provided as an illustrative example of the technique according to the present disclosure. Therefore, it is possible to make various changes, replacements, additions, omissions, and the like within the scope of the claims and equivalents thereof. Such modifications also fall within the technical scope of the present disclosure.

The present disclosure is applicable to various projection display apparatuses and projection optical systems mounted on the projection display apparatuses.

What is claimed is:

1. A projection optical system comprising
a plurality of lenses, wherein
the projection optical system projects projection light output from a video display element in a forward direction along an optical axis, to display an image formed on a display surface of the video display element onto a projection target,
the projection light having reflected on lens surfaces of the plurality of lenses form a ray passing through the projection optical system in a backward direction, and
each lens surface, among the lens surfaces in the projection optical system, satisfies following condition (1),
$$\vert X \vert > f / 2 \qquad ( 1 )$$
where, in ray tracing using paraxial ray tracing with a marginal ray of an axial light flux passing through the projection optical system, when a first ray is a reflection of the marginal ray propagated backwards on the display surface, X denotes a distance between the display surface and a convergence plane where a reflection of the first ray on the lens surface converges, and
f denotes a focal length of an entire system of the projection optical system.

2. A projection optical system comprising
a plurality of lenses, wherein
the projection optical system projects projection light output from a video display element in a forward direction along an optical axis, to display an image formed on a display surface of the video display element onto a projection target,
the projection light having reflected on lens surfaces of the plurality of lenses form a ray passing through the projection optical system in a backward direction, and
each lens surface, among the lens surfaces in the projection optical system, satisfies following condition (2),
$$\vert ( H * f / 2 F ) \vert > D \qquad ( 2 )$$
where, in ray tracing using paraxial ray tracing with a marginal ray of an axial light flux passing through the projection optical system, when a first ray is a reflection of the marginal ray propagated backwards on the display surface, H denotes a ray height, on the display surface, of a ray resultant of the first ray reflected on the lens surface, and D denotes a half a diagonal length of the display surface,
f is a focal length of the entire projection optical system, and
F is an f-number of the entire projection optical system.

3. A projection optical system comprising
a plurality of lenses, wherein
the projection optical system projects projection light output from a video display element in a forward direction along an optical axis, to display an image formed on a display surface of the video display element onto a projection target,
the projection light having reflected on lens surfaces of the plurality of lenses form a ray passing through the projection optical system in a backward direction, and
each lens surface, among the lens surfaces in the projection optical system, satisfies following condition (3),
$$1 / ( \vert θ \vert * h ) < 0.04 \qquad ( 3 )$$
where in ray tracing using actual ray tracing with a marginal ray of an axial light flux passing through the projection optical system, when θ deg. denotes an angle formed by the marginal ray having propagated forwards from the display surface and becoming incident on the lens surface, and a normal line of the lens surface on which the marginal ray becomes incident, and h (mm) denotes a ray height on the lens surface on which the marginal ray becomes incident.

4. A projection optical system comprising
a plurality of lenses, wherein
the projection optical system projects projection light output from a video display element in a forward direction along an optical axis, to display an image formed on a display surface of the video display element onto a projection target,
the projection light having reflected on lens surfaces of the plurality of lenses form a ray passing through the projection optical system in a backward direction, and
each lens surface, among the lens surfaces in the projection optical system, satisfies at least one of following conditions (1) to (3) in ray tracing with a marginal ray of an axial light flux passing through the projection optical system:
$$\vert X \vert > f / 2 ; \qquad ( 1 )$$
$$\vert ( H * f / 2 F ) \vert > D ; \qquad ( 2 )$$
$$and$$
$$1 / ( \vert θ \vert * h ) < 0 \text{.04} , \qquad ( 3 )$$
where, in the ray tracing using paraxial ray tracing when a first ray is a reflection of the marginal ray propagated backwards on the display surface, X denotes a distance between the display surface and a convergence plane where a reflection of the first ray on the lens surface converges,
f denotes a focal length of an entire system of the projection optical system,
H denotes a ray height, on the display surface, of a reflection of the first ray on the lens surface, among the lens surfaces, in the ray tracing using paraxial ray tracing,
F is an f-number of the entire projection optical system,
D denotes a half a diagonal length of the display surface,
θ deg. denotes an angle formed by the marginal ray having propagated forwards from the display surface and becoming incident on the lens surface, and a normal line of the lens surface on which the marginal ray becomes incident, in the ray tracing using actual ray tracing, and
h (mm) denotes a ray height, on the lens surface, when the marginal ray becomes incident on the lens surface.

5. The projection optical system according to claim 1, wherein the ray tracing is performed using a light wavelength included in the projection light.

6. The projection optical system according to claim 2, wherein the ray tracing is performed using a light wavelength included in the projection light.

7. The projection optical system according to claim 3, wherein the ray tracing is performed using a light wavelength included in the projection light.

8. The projection optical system according to claim 4, wherein the ray tracing is performed using a light wavelength included in the projection light.

9. The projection optical system according to claim 1, wherein
external light propagating from the projection target in the backward direction along the optical axis passes through the projection optical system, and light in a predetermined wavelength range in the external light forms a captured image, and
the ray tracing is performed using a light wavelength included in the predetermined wavelength range.

10. The projection optical system according to claim 2, wherein
external light propagating from the projection target in the backward direction along the optical axis passes through the projection optical system, and light in a predetermined wavelength range in the external light forms a captured image, and
the ray tracing is performed using a light wavelength included in the predetermined wavelength range.

11. The projection optical system according to claim 3, wherein
external light propagating from the projection target in the backward direction along the optical axis passes through the projection optical system, and light in a predetermined wavelength range in the external light forms a captured image, and
the ray tracing is performed using a light wavelength included in the predetermined wavelength range.

12. The projection optical system according to claim 4, wherein
external light propagating from the projection target in the backward direction along the optical axis passes through the projection optical system, and light in a predetermined wavelength range in the external light forms a captured image, and
the ray tracing is performed using a light wavelength included in the predetermined wavelength range.

13. A projection display apparatus including the projection optical system according to claim 1 and configured to project and to display a video on the projection target, the projection display apparatus comprising:
a light source device;
a projection light generator that includes the video display element and generates the projection light modulated in accordance with a video signal; and
a light-guide optical system that guides illumination light emitted from the light source device to the projection light generator,
wherein the ray tracing is performed using a light wavelength included in the projection light.

14. A projection display apparatus including the projection optical system according to claim 2 and configured to project and to display a video on the projection target, the projection display apparatus comprising:
a light source device;
a projection light generator that includes the video display element and generates the projection light modulated in accordance with a video signal; and
a light-guide optical system that guides illumination light emitted from the light source device to the projection light generator,
wherein the ray tracing is performed using a light wavelength included in the projection light.

15. A projection display apparatus including the projection optical system according to claim 3 and configured to project and to display a video on the projection target, the projection display apparatus comprising:
a light source device;
a projection light generator that includes the video display element and generates the projection light modulated in accordance with a video signal; and
a light-guide optical system that guides illumination light emitted from the light source device to the projection light generator,
wherein the ray tracing is performed using a light wavelength included in the projection light.

16. A projection display apparatus including the projection optical system according to claim 4 and configured to project and to display a video on the projection target, the projection display apparatus comprising:
a light source device;
a projection light generator that includes the video display element and generates the projection light modulated in accordance with a video signal; and
a light-guide optical system that guides illumination light emitted from the light source device to the projection light generator,
wherein the ray tracing is performed using a light wavelength included in the projection light.

17. A projection display apparatus including the projection optical system according to claim 1 and configured to project and to display a video on the projection target, the projection display apparatus comprising:
a light source device;
a projection light generator that includes the video display element and generates the projection light modulated in accordance with a video signal;
a light-guide optical system that guides illumination light emitted from the light source device to the projection light generator; and
an imaging optical system in which external light propagating from the projection target in the backward direction along the optical axis passes through the projection optical system and captures an image of light in a predetermined wavelength range among the external light,
wherein the ray tracing is performed using a light wavelength included in the predetermined wavelength range.

18. A projection display apparatus including the projection optical system according to claim 2 and configured to project and to display a video on the projection target, the projection display apparatus comprising:
a light source device;
a projection light generator that includes the video display element and generates the projection light modulated in accordance with a video signal;
a light-guide optical system that guides illumination light emitted from the light source device to the projection light generator; and
an imaging optical system in which external light propagating from the projection target in the backward direction along the optical axis passes through the projection optical system and captures an image of light in a predetermined wavelength range among the external light,
wherein the ray tracing is performed using a light wavelength included in the predetermined wavelength range.

19. A projection display apparatus including the projection optical system according to claim 3 and configured to project and to display a video on the projection target, the projection display apparatus comprising:
a light source device;
a projection light generator that includes the video display element and generates the projection light modulated in accordance with a video signal;
a light-guide optical system that guides illumination light emitted from the light source device to the projection light generator; and
an imaging optical system in which external light propagating from the projection target in the backward direction along the optical axis passes through the projection optical system and captures an image of light in a predetermined wavelength range among the external light,
wherein the ray tracing is performed using a light wavelength included in the predetermined wavelength range.

20. A projection display apparatus including the projection optical system according to claim 4 and configured to project and to display a video on the projection target, the projection display apparatus comprising:
a light source device;
a projection light generator that includes the video display element and generates the projection light modulated in accordance with a video signal;
a light-guide optical system that guides illumination light emitted from the light source device to the projection light generator; and
an imaging optical system in which external light propagating from the projection target in the backward direction along the optical axis passes through the projection optical system and captures an image of light in a predetermined wavelength range among the external light,
wherein the ray tracing is performed using a light wavelength included in the predetermined wavelength range.
